(19) United States
(12) Patent Application Publication
(10) Pub. No.: US 2024/0114168 A1
(43) Pub. Date: Apr. 4, 2024

(54) METHODS AND APPARATUS FOR SIGNALING 2D AND 3D REGIONS IN IMMERSIVE MEDIA

(71) Applicant: MEDIATEK Singapore Pte. Ltd., Singapore (SG)

(72) Inventors: Xin Wang, San Jose, CA (US); Lulin Chen, San Jose, CA (US)

(73) Assignee: MEDIATEK Singapore Pte. Ltd., Singapore (SG)

(21) Appl. No.: 18/532,993

(22) Filed: Dec. 7, 2023

Related U.S. Application Data
(63) Continuation of application No. 17/143,666, filed on Jan. 7, 2021.
(60) Provisional application No. 62/959,340, filed on Jan. 10, 2020.
(60) Provisional application No. 62/958,765, filed on Jan. 9, 2020.
(60) Provisional application No. 62/958,359, filed on Jan. 8, 2020.

(51) Int. Cl. H04N 19/597; G06T 7/11; H04N 13/161; H04N 13/178; H04N 19/167

(52) U.S. Cl. CPC H04N 19/597; G06T 7/11; H04N 13/161; H04N 13/178; H04N 19/167; H04N 19/70

(57) ABSTRACT

The techniques described herein relate to methods, apparatus, and computer readable media configured to encode and/or decode video data. Immersive media data includes a first patch track comprising first encoded immersive media data that corresponds to a first spatial portion of immersive media content, a second patch track comprising second encoded immersive media data that corresponds to a second spatial portion of the immersive media content that is different than the first spatial portion, an elementary data track comprising first immersive media elementary data, wherein the first patch track and/or the second patch track reference the elementary data track, and grouping data that specifies a spatial relationship between the first patch track and the second patch track. An encoding and/or decoding operation is performed based on the first patch track, the second patch track, the elementary data track and the grouping data to generate decoded immersive media data.

### RELATED APPLICATIONS

This Application is a Continuation of U.S. application Ser. No. 17/143,666, filed Jan. 7, 2021, titled “METHODS AND APPARATUS FOR SIGNALING 2D AND 3D REGIONS IN IMMERSIVE MEDIA”, which claims priority under 35 U.S.C. § 119(e) to U.S. Provisional Application Ser. No. 62/958,359, titled “METHODS OF NON-CUBOID SUBDIVISIONS FOR PARTIAL ACCESS OF POINT CLOUD DATA IN ISOBMFF,” filed Jan. 8, 2020, U.S. Provisional Application Ser. No. 62/958,765, titled “METHODS OF SIGNALING SURFICIAL AND VOLUMETRIC VIEWPORTS FOR IMMERSIVE MEDIA,” filed Jan. 9, 2020, and U.S. Provisional Application Ser. No. 62/959,340, titled “METHODS OF SIGNALING SURFICIAL AND VOLUMETRIC VIEWPORTS FOR IMMERSIVE MEDIA,” filed Jan. 10, 2020, each of which are herein incorporated by reference in their entirety.

### TECHNICAL FIELD

The techniques described herein relate generally to video coding, and particularly to methods and apparatus for signaling 2D and 3D regions in immersive media.

### BACKGROUND OF INVENTION

Various types of video content, such as 2D content, 3D content and multi-directional content exist. For example, omnidirectional video is a type of video that is captured using a set of cameras, as opposed to just a single camera as done with traditional unidirectional video. For example, cameras can be placed around a particular center point, so that each camera captures a portion of video on a spherical coverage of the scene to capture 360-degree video. Video from multiple cameras can be stitched, possibly rotated, and projected to generate a projected two-dimensional picture representing the spherical content. For example, an equal rectangle projection can be used to put the spherical map into a two-dimensional image. This can be done, for example, to use two-dimensional encoding and compression techniques. Ultimately, the encoded and compressed content is stored and delivered using a desired delivery mechanism (e.g., thumb drive, digital video disk (DVD) and/or online streaming). Such video can be used for virtual reality (VR), and/or 3D video.

At the client side, when the client processes the content, a video decoder decodes the encoded video and performs a reverse-projection to put the content back onto the sphere. A user can then view the rendered content, such as using a head-worn viewing device. The content is often rendered according to the user's viewport, which represents the angle at which the user is looking at the content. The viewport may also include a component that represents the viewing area, which can describe how large, and in what shape, the area is that is being viewed by the viewer at the particular angle.

When the video processing is not done in a viewport-dependent manner, such that the video encoder does not know what the user will actually view, then the whole encoding and decoding process will process the entire spherical content. This can allow, for example, the user to view the content at any particular viewport and/or area, since all of the spherical content is delivered and decoded.

However, processing all of the spherical content can be compute intensive and can consume significant bandwidth. For example, for online streaming applications, processing all of the spherical content can place a large burden on network bandwidth. Therefore, it can be difficult to preserve a user's experience when bandwidth resources and/or compute resources are limited. Some techniques only process the content being viewed by the user. For example, if the user is viewing the front (e.g., or north pole), then there is no need to deliver the back part of the content (e.g., the south pole). If the user changes viewports, then the content can be delivered accordingly for the new viewport. As another example, for free viewpoint TV (FTV) applications (e.g., which capture video of a scene using a plurality of cameras), the content can be delivered depending at which angle the user is viewing the scene. For example, if the user is viewing the content from one viewport (e.g., camera and/or neighboring cameras), there is probably no need to deliver content for other viewports.

### SUMMARY OF INVENTION

In accordance with the disclosed subject matter, apparatus, systems, and methods are provided for decoding immersive media.

Some embodiments relate to a decoding method for decoding video data for immersive media. The method includes accessing immersive media data including a set of one or more tracks, wherein each track of the set comprises associated encoded immersive media data that corresponds to an associated spatial portion of immersive media content that is different than the associated spatial portions of other tracks in the set of tracks, and region metadata specifying a viewing region in the immersive media content, wherein the region metadata can include two-dimensional (2D) region data or three-dimensional (3D) region data, the region metadata includes the 2D region metadata if the viewing region is a 2D region, and the region metadata includes the 3D region metadata if the viewing region is a 3D region. The method includes performing a decoding operation based on the set of one or more tracks and the region metadata to generate decoded immersive media data with the viewing region.

In some examples, the viewing region includes a sub-portion of the viewable immersive media data that is less than a full viewable portion of the immersive media data. The viewing region can be a viewport.

In some examples, performing the decoding operation includes determining a shape type of the viewing region, and decoding the region metadata based on the shape type.

In some examples, determining the shape type comprises determining the viewing region is a 2D rectangle, and the method includes determining a region width and a region height from the 2D region metadata specified by the region metadata, and generating the decoded immersive media data with a 2D rectangular viewing region with a width equal to the region width and a height equal to the region height.

In some examples, determining the shape type comprises determining the viewing region is a 2D circle, and the method further includes determining a region radius from the 2D region metadata specified by the region metadata, and generating the decoded immersive media data with a 2D circular viewing region with a radius equal to the region radius.

In some examples, determining the shape type comprises determining the viewing region is a 3D spherical region, and the method further includes determining a region azimuth and a region elevation from the 3D region metadata specified by the region metadata, and generating the decoded immersive media data with a 3D spherical viewing region with an azimuth equal to the region azimuth and an elevation equal to the region elevation.

In some examples, a track from the set of one or more tracks comprises encoded immersive media data that corresponds to a spatial portion of the immersive media specified by a spherical subdivision of the immersive media. The spherical subdivision can include a center of the spherical subdivision in the immersive media, an azimuth of the spherical subdivision in the immersive media, and an elevation of the spherical subdivision in the immersive media.

In some examples, a track from the set of one or more tracks comprises encoded immersive media data that corresponds to a spatial portion of the immersive media specified by a pyramid subdivision of the immersive media. The pyramid subdivision can include four vertices that specify bounds of the pyramid subdivision in the immersive media.

In some examples, the immersive media data further includes an elementary data track comprising first immersive media elementary data, wherein at least one track of the set of one or more tracks references the elementary data track.

In some examples, the elementary data track includes at least one geometry track comprising geometry data of the immersive media, at least one attribute track comprising attribute data of the immersive media, and an occupancy track comprising occupancy map data of the immersive media, accessing the immersive media data includes accessing the geometry data in the at least one geometry track, the attribute data in the at least one attribute track, and the occupancy map data of the occupancy track, and performing the decoding operation comprises performing the decoding operation using the geometry data, the attribute data, and the occupancy map data, to generate the decoded immersive media data.

Some embodiments relate to a method for encoding video data for immersive media. The method includes encoding immersive media data, including encoding at least a set of one or more tracks, wherein each track of the set comprises associated encoded immersive media data that corresponds to an associated spatial portion of immersive media content that is different than the associated spatial portions of other tracks in the set of tracks, and region metadata specifying a viewing region in the immersive media content, wherein the region metadata can include two-dimensional (2D) region data or three-dimensional (3D) region data, the region metadata includes the 2D region metadata if the viewing region is a 2D region, and the region metadata includes the 3D region metadata if the viewing region is a 3D region, wherein the encoded immersive media data can be used to perform a decoding operation based on the set of one or more tracks and the region metadata to generate decoded immersive media data with the viewing region.

In some examples, a shape type of the viewing region is a 2D rectangle, and the 2D region metadata specifies a region width and a region height.

In some examples, a shape type of the viewing region is a 2D circle, and the 2D region metadata specifies a region radius.

In some examples, a shape type of the viewing region comprises a 3D spherical region, and the 3D region metadata specifies a region azimuth and a region elevation.

Some embodiments relate to an apparatus configured to decode video data. The apparatus includes a processor in communication with memory, the processor being configured to execute instructions stored in the memory that cause the processor to perform accessing immersive media data including a set of one or more tracks, wherein each track of the set comprises associated encoded immersive media data that corresponds to an associated spatial portion of immersive media content that is different than the associated spatial portions of other tracks in the set of tracks, and region metadata specifying a viewing region in the immersive media content, wherein the region metadata can include two-dimensional (2D) region data or three-dimensional (3D) region data, the region metadata includes the 2D region metadata if the viewing region is a 2D region, and the region metadata includes the 3D region metadata if the viewing region is a 3D region. The processor is configured to execute instructions stored in the memory that cause the processor to perform a decoding operation based on the set of one or more tracks and the region metadata to generate decoded immersive media data with the viewing region.

In some examples, the processor is further configured to execute instructions stored in the memory that cause the processor to perform determining a shape type of the viewing region is a 2D circle, determining a region radius from the 2D region metadata specified by the region metadata, and generating the decoded immersive media data with a 2D circular viewing region with a radius equal to the region radius.

In some examples, the processor is further configured to execute instructions stored in the memory that cause the processor to perform determining a shape type of the viewing region is a 3D spherical region, determining a region azimuth and a region elevation from the 3D region metadata specified by the region metadata, and generating the decoded immersive media data with a 3D spherical viewing region with an azimuth equal to the region azimuth and an elevation equal to the region elevation.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows an exemplary video coding configuration, according to some embodiments.

FIG. 2 shows a viewport dependent content flow process for VR content, according to some examples.

FIG. 3 shows an exemplary processing flow for point cloud content, according to some examples.

FIG. 4 shows an example of a free-view path, according to some examples.

FIG. 5 is a diagram showing exemplary point cloud tiles, including 3D and 2D bounding boxes, according to some examples.

FIG. 6 shows a V-PCC bitstream that is composed of a set of V-PCC units, according to some examples.

FIG. 7 shows an ISOBMFF-based V-PCC container, according to some examples.

FIG. 8 is an exemplary diagram showing metadata data structures for 3D elements, according to some embodiments.

FIG. 9 is an exemplary diagram showing metadata data structures for 2D elements, according to some embodiments.

FIG. 10 is an exemplary diagram showing metadata data structures for 2D and 3D elements, according to some embodiments.

FIG. 11 is an exemplary diagram showing metadata data structures for viewports with 3DoF and 6DoFs, according to some embodiments.

FIG. 12 is a diagram of exemplary sample entry and sample format for signaling a viewport with 3DoF (e.g. for 2D faces/tiles in 3D space and/or the like) in timed metadata tracks, according to some embodiments.

FIG. 13A shows an exemplary region of point cloud content specified using spherical coordinates, according to some embodiments.

FIG. 13B shows an exemplary spherical region structure, according to some embodiments.

FIG. 14 shows exemplary syntaxes that can be used to specify a spherical region, according to some embodiments

FIG. 15 shows an exemplary pyramid region, according to some embodiments.

FIG. 16 shows exemplary syntaxes that can be used to specify a pyramid region, according to some embodiments.

FIG. 17 shows exemplary schematics of volumetric viewports, according to some embodiments.

FIG. 18 shows an exemplary 2D range structure that can specify a volumetric viewport, according to some embodiments.

FIG. 19 shows an exemplary viewport with 6DoF structure, according to some embodiments.

FIG. 20 shows an exemplary 6DOF viewport sample entry that supports volumetric viewports, according to some embodiments.

FIG. 21 shows a 6DoF viewport sample that supports volumetric viewports, according to some embodiments.

FIG. 22 is an exemplary diagram showing a near view shape and a far view shape, according to some embodiments.

FIG. 23 shows an exemplary viewport with 6DoF structure that includes far-side view information, according to some embodiments.

FIG. 24 is an exemplary diagram of a computerized method for encoding or decoding video data for immersive media, according to some embodiments.

### DETAILED DESCRIPTION OF INVENTION

Point cloud data or other immersive media, such as Video-based Point Cloud Compression (V-PCC) data, can provide compressed point cloud data for various types of 3D multimedia applications. Conventional storage structures for point cloud content present the point cloud content (e.g., V-PCC component tracks) as a time-series sequence of units (e.g., V-PCC units) that encode the entire immersive media content, and can also include a collection of component data tracks (e.g., geometry, texture, and/or occupancy tracks). Such conventional techniques do not allow for specifying regions, such as viewports, other than as a rectangular two-dimensional surface. The inventors have appreciated deficiencies with such limitations, including the fact that only providing 2D surficial viewports can limit the user's experience, limit the robustness of the content provided to the user, and/or the like. It can therefore be desirable to provide techniques for encoding and/or decoding regions of point cloud video data using other approaches, such as spherical surfaces and/or spatial volumes. The techniques described herein provide for point cloud content structures that can support enhanced region specifications, including volumetric regions and viewports. In some embodiments, the techniques can be used to provide immersive experiences that are not otherwise achievable with conventional techniques. In some embodiments, the techniques can be used with devices that can display volumetric content (e.g., devices that can display more than just 2D planar content). Since such devices may be capable of displaying 3D volumetric viewports directly, the techniques can provide more immersive experiences compared to conventional techniques.

Point cloud content can be subdivided in cuboid subdivisions. However, such cuboid subdivisions limit the granularity with which conventional techniques can process point cloud content. Further, cuboid subdivisions may not be able to adequately capture relevant point cloud content. The inventors have appreciated, therefore, that it can be desirable to subdivide point cloud content in other manners. The inventors have therefore developed technical improvements to point cloud technology to provide for non-cuboid subdivisions, such as spherical subdivisions and/or pyramid subdivisions. Such non-cuboid subdivision techniques can be used to support flexible signalling of sub-divisions of a point cloud object into a number of 3D spatial sub-regions. Non-cuboid regions can be useful when mapping 3D spatial sub-regions of a point cloud object onto surficial and/or volumetric viewports. As another example, the spherical subdivision techniques can be useful for point clouds whose points can be within a 3D bounding box and whose shape is spherical rather than cuboid.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

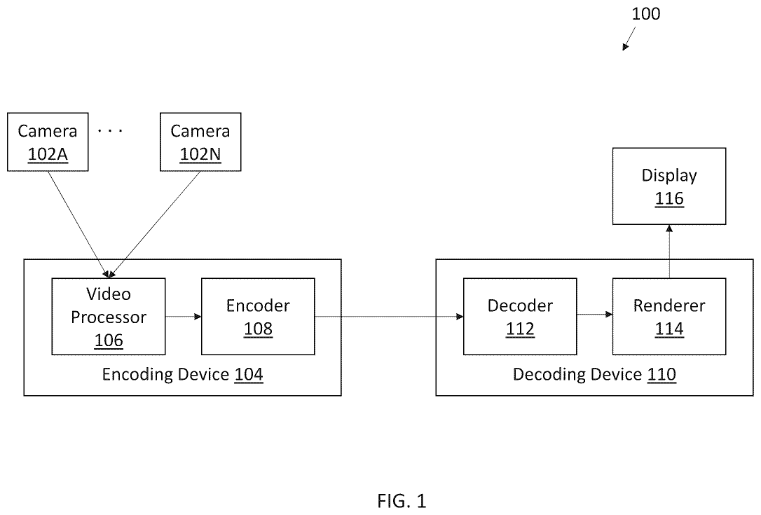

FIG. 1 shows an exemplary video coding configuration 100, according to some embodiments. Cameras 102A-102N are N number of cameras, and can be any type of camera (e.g., cameras that include audio recording capabilities, and/or separate cameras and audio recording functionality). The encoding device 104 includes a video processor 106 and an encoder 108. The video processor 106 processes the video received from the cameras 102A-102N, such as stitching, projection, and/or mapping. The encoder 108 encodes and/or compresses the two-dimensional video data. The decoding device 110 receives the encoded data. The decoding device 110 may receive the video as a video product (e.g., a digital video disc, or other computer readable media), through a broadcast network, through a mobile network (e.g., a cellular network), and/or through the Internet. The decoding device 110 can be, for example, a computer, a portion of a head-worn display, or any other apparatus with decoding capability. The decoding device 110 includes a decoder 112 that is configured to decode the encoded video. The decoding device 110 also includes a renderer 114 for rendering the two-dimensional content back to a format for playback. The display 116 displays the rendered content from the renderer 114.

Generally, 3D content can be represented using spherical content to provide a 360 degree view of a scene (e.g., sometimes referred to as omnidirectional media content). While a number of views can be supported using the 3D sphere, an end user typically just views a portion of the content on the 3D sphere. The bandwidth required to transmit the entire 3D sphere can place heavy burdens on a network, and may not be sufficient to support spherical content. It is therefore desirable to make 3D content delivery more efficient. Viewport dependent processing can be performed to improve 3D content delivery. The 3D spherical content can be divided into regions/tiles/sub-pictures, and only those related to viewing screen (e.g., viewport) can be transmitted and delivered to the end user.

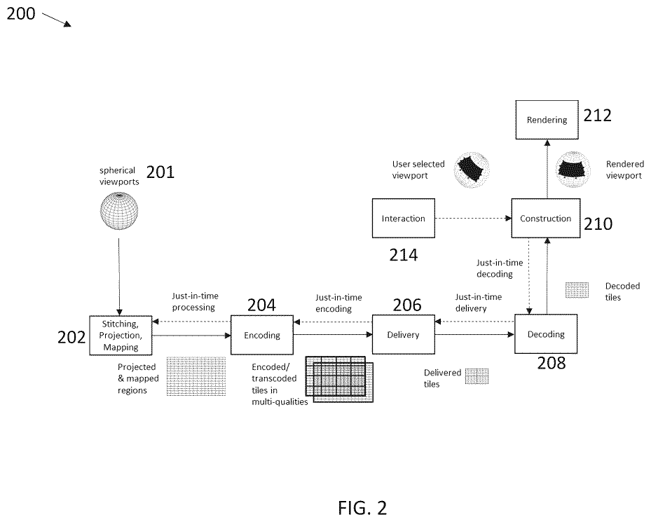

FIG. 2 shows a viewport dependent content flow process 200 for VR content, according to some examples. As shown, spherical viewports 201 (e.g., which could include the entire sphere) undergo stitching, projection, mapping at block 202 (to generate projected and mapped regions), are encoded at block 204 (to generate encoded/transcoded tiles in multiple qualities), are delivered at block 206 (as tiles), are decoded at block 208 (to generate decoded tiles), are constructed at block 210 (to construct a spherical rendered viewport), and are rendered at block 212. User interaction at block 214 can select a viewport, which initiates a number of “just-in-time” process steps as shown via the dotted arrows.

In the process 200, due to current network bandwidth limitations and various adaptation requirements (e.g., on different qualities, codecs and protection schemes), the 3D spherical VR content is first processed (stitched, projected and mapped) onto a 2D plane (by block 202) and then encapsulated in a number of tile-based (or sub-picture-based) and segmented files (at block 204) for delivery and playback. In such a tile-based and segmented file, a spatial tile in the 2D plane (e.g., which represents a spatial portion, usually in a rectangular shape of the 2D plane content) is typically encapsulated as a collection of its variants, such as in different qualities and bitrates, or in different codecs and protection schemes (e.g., different encryption algorithms and modes). In some examples, these variants correspond to representations within adaptation sets in MPEG DASH. In some examples, it is based on user's selection on a viewport that some of these variants of different tiles that, when put together, provide a coverage of the selected viewport, are retrieved by or delivered to the receiver (through delivery block 206), and then decoded (at block 208) to construct and render the desired viewport (at blocks 210 and 212).

As shown in FIG. 2, the viewport notion is what the end-user views, which involves the angle and the size of the region on the sphere. For 360 degree content, generally, the techniques deliver the needed tiles/sub-picture content to the client to cover what the user will view. This process is viewport dependent because the techniques only deliver the content that covers the current viewport of interest, not the entire spherical content. The viewport (e.g., a type of spherical region) can change and is therefore not static. For example, as a user moves their head, then the system needs to fetch neighboring tiles (or sub-pictures) to cover the content of what the user wants to view next.

A region of interest (ROI) is somewhat similar in concept to viewport. An ROI may, for example, represent a region in 3D or 2D encodings of omnidirectional video. An ROI can have different shapes (e.g., a square, or a circle), which can be specified in relation to the 3D or 2D video (e.g., based on location, height, etc.). For example, a region of interest can represent an area in a picture that can be zoomed-in, and corresponding ROI video can be displayed for the zoomed-in video content. In some implementations, the ROI video is already prepared. In such implementations, a region of interest typically has a separate video track that carries the ROI content. Thus, the encoded video specifies the ROI, and how the ROI video is associated with the underlying video. The techniques described herein are described in terms of a region, which can include a viewport, a ROI, and/or other areas of interest in video content.

ROI or viewport tracks can be associated with main video. For example, an ROI can be associated with a main video to facilitate zoom-in and zoom-out operations, where the ROI is used to provide content for a zoom-in region. For example, MPEG-B, Part 10, entitled “Carriage of Timed Metadata Metrics of Media in ISO Base Media File Format,” dated Jun. 2, 2016 (w16191, also ISO/IEC 23001-10:2015), which is hereby incorporated by reference herein in its entirety, describes an ISO Base Media File Format (ISOBMFF) file format that uses a timed metadata track to signal that a main 2D video track has a 2D ROI track. As another example, Dynamic Adaptive Streaming over HTTP (DASH) includes a spatial relationship descriptor to signal the spatial relationship between a main 2D video representation and its associated 2D ROI video representations. ISO/IEC 23009-1, draft third edition (w10225), Jul. 29, 2016, addresses DASH, and is hereby incorporated by reference herein in its entirety. As a further example, the Omnidirectional MediA Format (OMAF) is specified in ISO/IEC 23090-2, which is hereby incorporated by reference herein in its entirety. OMAF specifies the omnidirectional media format for coding, storage, delivery, and rendering of omnidirectional media. OMAF specifies a coordinate system, such that the user's viewing perspective is from the center of a sphere looking outward towards the inside surface of the sphere. OMAF includes extensions to ISOBMFF for omnidirectional media as well as for timed metadata for sphere regions.

When signaling an ROI, various information may be generated, including information related to characteristics of the ROI (e.g., identification, type (e.g., location, shape, size), purpose, quality, rating, etc.). Information may be generated to associate content with an ROI, including with the visual (3D) spherical content, and/or the projected and mapped (2D) frame of the spherical content. An ROI can be characterized by a number of attributes, such as its identification, location within the content it is associated with, and its shape and size (e.g., in relation to the spherical and/or 3D content). Additional attributes like quality and rate ranking of the region can also be added, as discussed further herein.

Point cloud data can include a set of 3D points in a scene. Each point can be specified based on an (x, y, z) position and color information, such as (R,V,B), (Y,U,V), reflectance, transparency, and/or the like. The point cloud points are typically not ordered, and typically do not include relations with other points (e.g., such that each point is specified without reference to other points). Point cloud data can be useful for many applications, such as 3D immersive media experiences that provide 6DoF. However, point cloud information can consume a significant amount of data, which in turn can consume a significant amount of bandwidth if being transferred between devices over network connections. For example, 800,000 points in a scene can consume 1 Gbps, if uncompressed. Therefore, compression is typically needed in order to make point cloud data useful for network-based applications.

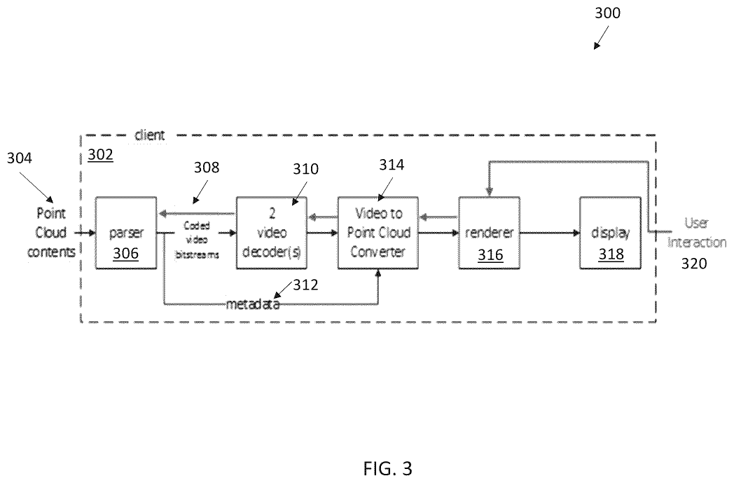

MPEG has been working on point cloud compression to reduce the size of point cloud data, which can enable streaming of point cloud data in real-time for consumption on other devices. FIG. 3 shows an exemplary processing flow 300 for point cloud content as a specific instantiation of the general viewport/ROI (e.g., 3DoF/6DoF) processing model, according to some examples. The processing flow 300 is described in further detail in, for example, N17771, “PCC WD V-PCC (Video-based PCC),” July 2018, Ljubljana, SI, which is hereby incorporated by reference herein in its entirety. The client 302 receives the point cloud media content file 304, which is composed of two 2D planar video bit streams and metadata that specifies a 2D planar video to 3D volumetric video conversion. The content 2D planar video to 3D volumetric video conversion metadata can be located either at the file level as timed metadata track(s) or inside the 2D video bitstream as SEI messages.

The parser module 306 reads the point cloud contents 304. The parser module 306 delivers the two 2D video bitstreams 308 to the 2D video decoder 310. The parser module 306 delivers the 2D planar video to 3D volumetric video conversion metadata 312 to the 2D video to 3D point cloud converter module 314. The parser module 306 at the local client can deliver some data that requires remote rendering (e.g., with more computing power, specialized rendering engine, and/or the like) to a remote rendering module (not shown) for partial rendering. The 2D video decoder module 310 decodes the 2D planar video bitstreams 308 to generate 2D pixel data. The 2D video to 3D point cloud converter module 314 converts the 2D pixel data from the 2D video decoder(s) 310 to 3D point cloud data if necessary using the metadata 312 received from the parser module 306.

The renderer module 316 receives information about users' six-degree viewport information and determines the portion of the point cloud media to be rendered. If a remote renderer is used, the users' 6DoF viewport information can also be delivered to the remote render module. The renderer module 316 generates point cloud media by using 3D data, or a combination of 3D data and 2D pixel data. If there are partially rendered point cloud media data from a remote renderer module, then the renderer 316 can also combine such data with locally rendered point cloud media to generate the final point cloud video for display on the display 318. User interaction information 320, such as a user's location in 3D space or the direction and viewpoint of the user, can be delivered to the modules involved in processing the point cloud media (e.g., the parser 306, the 2D video decoder(s) 310, and/or the video to point cloud converter 314) to dynamically change the portion of the data for adaptive rendering of content according to the user's interaction information 320.

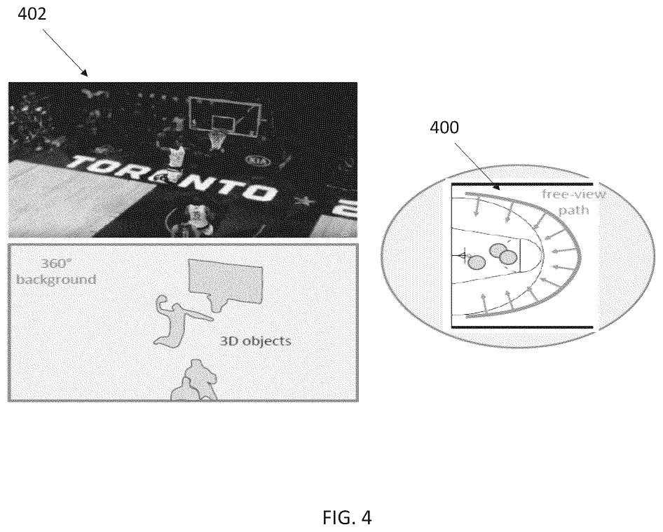

User interaction information for point cloud media needs to be provided in order to achieve such user interaction-based rendering. In particular, the user interaction information 320 needs to be specified and signaled in order for the client 302 to communicate with the render module 316, including to provide information of user-selected viewports. Point cloud content can be presented to the user via editor cuts, or as recommended or guided views or viewports. FIG. 4 shows an example of a free-view path 400, according to some examples. The free-view path 400 allows the user to move about the path to view the scene 402 from different viewpoints.

Viewports, such as recommended viewports (e.g., Video-based Point Cloud Compression (V-PCC) viewports), can be signaled for point cloud content. A point cloud viewport, such as a PCC (e.g., V-PCC or G-PCC (Geometry based Point Cloud Compression)) viewport, can be a region of point cloud content suitable for display and viewing by a user. Depending on a user's viewing device(s), the viewport can be a 2D viewport or a 3D viewport. For example, a viewport can be a 3D spherical region or a 2D planar region in the 3D space, with six degrees of freedom (6 DoF). The techniques can leverage 6D spherical coordinates (e.g., ‘6dsc’) and/or 6D Cartesian coordinates (e.g., ‘6dcc’) to provide point cloud viewports. Viewport signaling techniques, including leveraging ‘6dsc’ and ‘6dcc,’ are described in co-owned U.S. patent application Ser. No. 16/738,387, titled “Methods and Apparatus for Signaling Viewports and Regions of Interest for Point Cloud Multimedia Data,” which is hereby incorporated by reference herein in its entirety. The techniques can include the 6D spherical coordinates and/or 6D Cartesian coordinates as timed metadata, such as timed metadata in ISOBMFF. The techniques can use the 6D spherical coordinates and/or 6D Cartesian coordinates to specify 2D point cloud viewports and 3D point cloud viewports, including for V-PCC content stored in ISOBMFF files. The ‘6dsc’ and ‘6dcc’ can be natural extensions to the 2D Cartesian coordinates ‘2dcc’ for planar regions in the 2D space, as provided for in MPEG-B part 10.

In V-PCC, the geometry and texture information of a video-based point cloud is converted to 2D projected frames and then compressed as a set of different video sequences. The video sequences can be of three types: one representing the occupancy map information, a second representing the geometry information and a third representing the texture information of the point cloud data. A geometry track may contain, for example, one or more geometric aspects of the point cloud data, such as shape information, size information, and/or position information of a point cloud. A texture track may contain, for example, one or more texture aspects of the point cloud data, such as color information (e.g., RGB (Red, Green, Blue) information), opacity information, reflectance information and/or albedo information of a point cloud. These tracks can be used for reconstructing the set of 3D points of the point cloud. Additional metadata needed to interpret the geometry and video sequences, such as auxiliary patch information, can also be generated and compressed separately. While examples provided herein are explained in the context of V-PCC, it should be appreciated that such examples are intended for illustrative purposes, and that the techniques described herein are not limited to V-PCC.

V-PCC has yet to finalize a track structure. An exemplary track structure under consideration in the working draft of V-PCC in ISOBMFF is described in N18059, “WD of Storage of V-PCC in ISOBMFF Files,” October 2018, Macau, CN, which is hereby incorporated by reference herein in its entirety. The track structure can include a track that includes a set of patch streams, where each patch stream is essentially a different view for looking at the 3D content. As an illustrative example, if the 3D point cloud content is thought of as being contained within a 3D cube, then there can be six different patches, with each patch being a view of one side of the 3D cube from the outside of the cube. The track structure also includes a timed metadata track and a set of restricted video scheme tracks for geometry, attribute (e.g., texture), and occupancy map data. The timed metadata track contains V-PCC specified metadata (e.g., parameter sets, auxiliary information, and/or the like). The set of restricted video scheme tracks can include one or more restricted video scheme tracks that contain video-coded elementary streams for geometry data, one or more restricted video scheme tracks that contain video coded elementary streams for texture data, and a restricted video scheme track containing a video-coded elementary stream for occupancy map data. The V-PCC track structure can allow changing and/or selecting different geometry and texture data, together with the timed metadata and the occupancy map data, for variations of viewport content. It can be desirable to include multiple geometry and/or texture tracks for a variety of scenarios. For example, the point cloud may be encoded in both a full quality and one or more reduced qualities, such as for the purpose of adaptive streaming. In such examples, the encoding may result in multiple geometry/texture tracks to capture different samplings of the collection of 3D points of the point cloud. Geometry/texture tracks corresponding to finer samplings can have better qualities than those corresponding to coarser samplings. During a session of streaming the point cloud content, the client can choose to retrieve content among the multiple geometry/texture tracks, in either a static or dynamic manner (e.g., according to client's display device and/or network bandwidth).

A point cloud tile can represent 3D and/or 2D aspects of point cloud data. For example, as described in N18188, entitled “Description of PCC Core Experiment 2.19 on V-PCC tiles, Marrakech, MA (January 2019), V-PCC tiles can be used for Video-based PCC. An example of Video-based PCC is described in N18180, entitled “ISO/IEC 23090-5: Study of CD of Video-based Point Cloud Compression (V-PCC),” Marrakech, MA (January 2019). Both N18188 and N18180 are hereby incorporated by reference herein in their entirety. A point cloud tile can include bounding regions or boxes to represent the content or portions thereof, including bounding boxes for the 3D content and/or bounding boxes for the 2D content. In some examples, a point cloud tile includes a 3D bounding box, an associated 2D bounding box, and one or more independent coding unit(s) (ICUs) in the 2D bounding box. A 3D bounding box can be, for example, a minimum enclosing box for a given point set in three dimensions. A 3D bounding box can have various 3D shapes, such as the shape of a rectangular parallel-piped that can be represented by two 3-tuples (e.g., the origin and the length of each edge in three dimensions). A 2D bounding box can be, for example, a minimum enclosing box (e.g., in a given video frame) corresponding to the 3D bounding box (e.g., in 3D space). A 2D bounding box can have various 2D shapes, such as the shape of a rectangle that can be represented by two 2-tuples (e.g., the origin and the length of each edge in two dimensions). There can be one or more ICUs (e.g., video tiles) in a 2D bounding box of a video frame. The independent coding units can be encoded and/or decoded without the dependency of neighboring coding units.

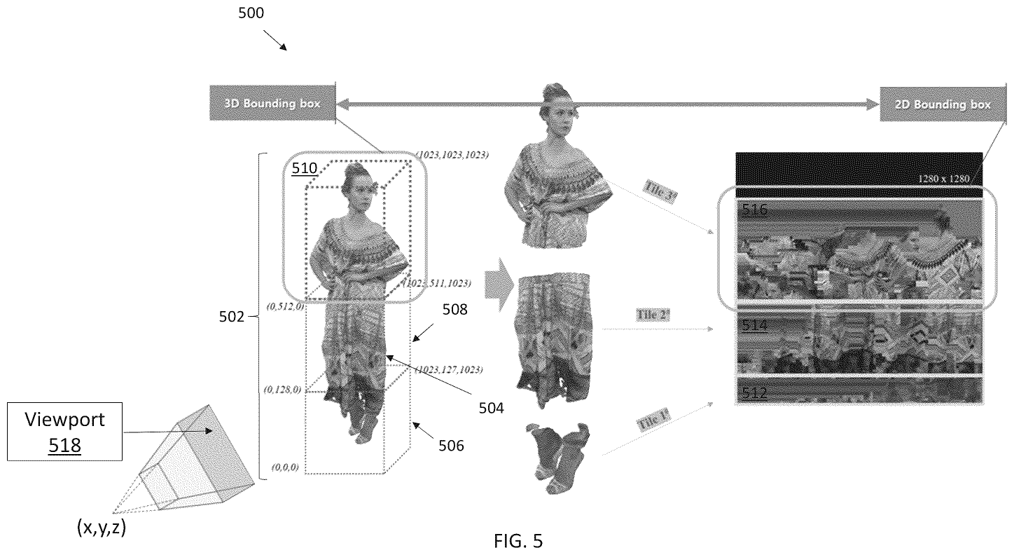

FIG. 5 is a diagram showing exemplary point cloud tiles, including 3D and 2D bounding boxes, according to some examples. Point cloud content typically only includes a single 3D bounding box around the 3D content, shown in FIG. 5 as the large box 502 surrounding the 3D point cloud content 504. As described above, a point cloud tile can include a 3D bounding box, an associated 2D bounding box, and one or more independent coding unit(s) (ICUs) in the 2D bounding box. To support viewport dependent processing, the 3D point cloud content typically needs to be subdivided into smaller pieces or tiles. FIG. 5 shows, for example, the 3D bounding box 502 can be divided into smaller 3D bounding boxes 506, 508 and 510, which each have an associated 2D bounding box 512, 514 and 516, respectively.

As described herein, some embodiments of the techniques can include, for example, sub-dividing the tiles (e.g., sub-dividing 3D/2D bounding boxes) into smaller units to form desired ICUs for V-PCC content. The techniques can encapsulate the sub-divided 3D volumetric regions and 2D pictures into tracks, such as into ISOBMFF visual (e.g., sub-volumetric and sub-picture) tracks. For example, the content of each bounding box can be stored into an associated sets of tracks, where each of the sets of tracks stores the content of one of the sub-divided 3D sub-volumetric regions and/or 2D sub-pictures. For the 3D sub-volumetric case, such a set of tracks include tracks that store geometry, attribute and texture attributes. For the 2D sub-picture case, such a set of tracks may just contain a single track that stores the sub-picture content. The techniques can provide for signaling relationships among the sets of tracks, such as signaling the respective 3D/2D spatial relationships of the sets of tracks using track groups and/or sample groups of ‘3dcc’ and ‘2dcc’ types. The techniques can signal the tracks associated with a particular bounding box, a particular sub-volumetric region or a particular sub-picture, and/or can signal relationships among the sets of tracks of different bounding boxes, sub-volumetric regions and sub-pictures. Providing point cloud content in separate tracks can facilitate advanced media processing not otherwise available for point cloud content, such as point cloud tiling (e.g., V-PCC tiling) and viewport-dependent media processing.

In some embodiments, the point cloud bounding boxes into sub-units. For example, the 3D and 2D bounding boxes can be sub-divided into 3D sub-volumetric boxes and 2D sub-picture regions, respectively. The sub-regions can provide ICUs that are sufficient for track-based rendering techniques. For example, the sub-regions can provide ICUs that are fine enough from a systems point of view for delivery and rendering in order to support the viewport dependent media processing. In some embodiments, the techniques can support viewport dependent media processing for V-PCC media content, e.g., as provided in m46208, entitled “Timed Metadata for (Recommended) Viewports of V-PCC Content in ISOBMFF,” Marrakech, MA (January 2019), which his hereby incorporated by reference herein in its entirety. As described further herein, each of the sub-divided 3D sub-volumetric boxes and 2D sub-picture regions can be stored in tracks in a similar manner as if they are (e.g., un-sub-divided) 3D boxes and 2D pictures, respectively, but with smaller sizes in terms of their dimensions. For example, in the 3D case, a sub-divided 3D sub-volumetric box/region will be stored in a set of tracks comprising geometry, texture and attribute tracks. As another example, in the 2D case, a sub-divided sub-picture region will be stored in a single (sub-picture) track. As a result of sub-dividing the content into smaller sub-volumes and sub-pictures, the ICUs can be carried in various ways. For example, in some embodiments different sets of tracks can be used to carry different sub-volumes or sub-pictures, such that the tracks carrying the sub-divided content have less data compared to when storing all of the un-sub-divided content. As another example, in some embodiments some and/or all of the data (e.g., even when subdivided) can be stored in the same tracks, but with smaller units for the sub-divided data and/or ICUs (e.g., so that the ICUs can be individually accessed in the overall set of track(s)).

The subdivided 2D and 3D regions may be of various shapes, such as squares, cubes, rectangles, and/or arbitrary shapes. The division along each dimension may not be binary. Therefore, each division tree of an outer-most 2D/3D bounding box can be much more general than the quadtree and octree examples provided herein. It should therefore be appreciated that various shapes and subdivision strategies can be used to determine each leaf region in the division tree, which represents an ICU (in the 2D or 3D space or bounding box). As described herein, the ICUs can be configured such that for end-to-end media systems the ICUs support viewport dependent processing (including delivery and rendering). For example, the ICUs can be configured according to m46208, where a minimal number of ICUs can be spatially randomly accessible for covering a viewport that is potentially dynamically moving (e.g., for instance, controlled by the user on a viewing device or based on a recommendation from the editor).

The point cloud ICUs can be carried in associated, separate tracks. In some embodiments, the ICUs and division trees can be carried and/or encapsulated in respective sub-volumetric and sub-picture tracks and track groups. The spatial relationship and sample groups of the sub-volumetric and sub-picture tracks and track groups can be signaled in, for example, ISOBMFF as described in ISO/IEC 14496-12.

Some embodiments can leverage, for the 2D case, the generic sub-picture track grouping extensions with the track grouping type ‘2dcc’ as provided in OMAF, e.g., as provided in Section 7.1.11 of the working draft of OMAF, 2nd Edition, N18227, entitled “WD 4 of ISO/IEC 23090-2 OMAF 2nd edition,” Marrakech, MA (January 2019), which is hereby incorporated by reference herein in its entirety. Some embodiments can update and extend, for the 3D case, the generic sub-volumetric track grouping extension with a new track grouping type ‘3dcc’. Such 3D and 2D track grouping mechanisms, can be used to group the example (leaf node) sub-volumetric tracks in the octree decomposition and sub-picture tracks in the quadtree decomposition into three ‘3dcc’ and ‘2dcc’ track groups, respectively.

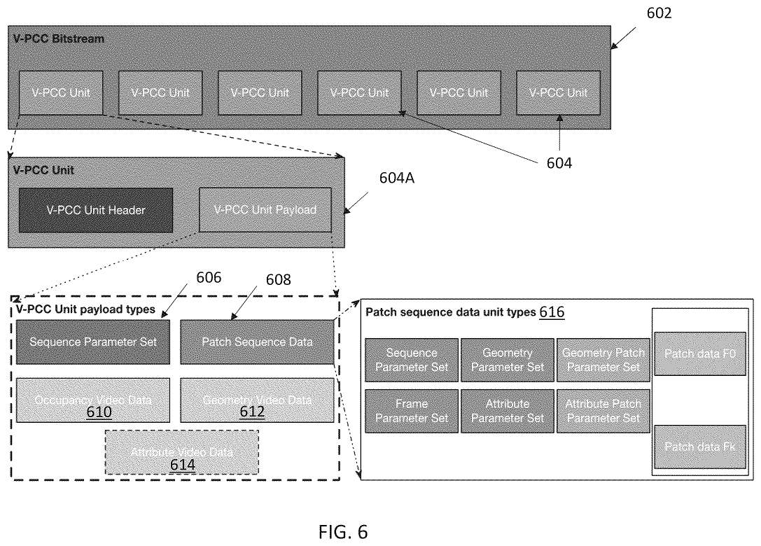

A point cloud bit stream can include a set of units that carry the point cloud content. The units can allow, for example, random access to the point cloud content (e.g., for ad insertion and/or other time-based media processing). For example, V-PCC can include a set of V-PCC Units, as described in N18180, “ISO/IEC 23090-5: Study of CD of Video-based Point Cloud Compression (V-PCC),” Marrakech, MA. January 2019, which is hereby incorporated by reference herein in its entirety. FIG. 6 shows a V-PCC bitstream 602 that is composed of a set of V-PCC units 604, according to some examples. Each V-PCC unit 604 has a V-PCC unit header and a V-PCC unit payload, as shown for V-PCC unit 604A, which includes V-PCC unit header and a V-PCC unit payload. The V-PCC unit header describes the V-PCC unit type. The V-PCC unit payload can include a sequence parameter set 606, patch sequence data 608, occupancy video data 610, geometry video data 612, and attribute video data 614. The patch sequence data unit 608 can include one or more patch sequence data unit types 616 as shown (e.g., sequence parameter set, frame parameter set, geometry parameter set, attribute parameter set, geometry patch parameter set, attribute patch parameter set, and/or patch data, in this non-limiting example).

In some examples, the occupancy, geometry, and attribute Video Data unit payloads 610, 612 and 614, respectively, correspond to video data units that could be decoded by the video decoder specified in the corresponding occupancy, geometry, and attribute parameter set V-PCC units. Referring to the patch sequence data unit types, V-PCC considers an entire 3D bounding box (e.g., 502 in FIG. 5) to be a cube, and considers projection onto one surface of the cube to be a patch (e.g., such that there can be six patches for each side). Therefore, the patch information can be used to indicate how the patches are encoded and relate to each other.

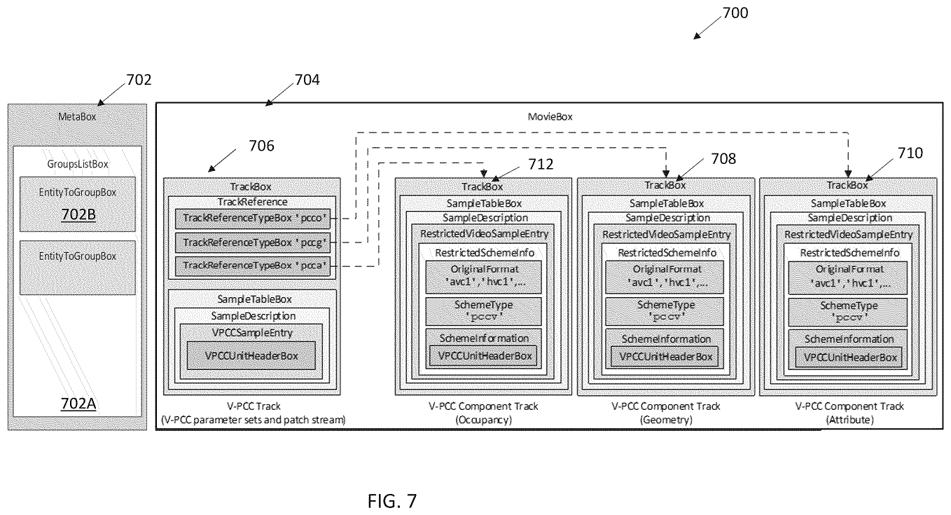

FIG. 7 shows an ISOBMFF-based V-PCC container 700, according to some examples. The container 700 can be, for example, as documented in the latest WD of Carriage of Point Cloud Data N18266m “WD of ISO/IEC 23090-10 Carriage of PC data,” Marrakech, MA. January 2019, which is hereby incorporated by reference herein in its entirety. As shown, the V-PCC container 700 includes a metadata box 702 and a movie box 704 that includes a V-PCC parameter track 706, a geometry track 708, an attribute track 710, and an occupancy track 712. Therefore, the movie box 704 includes the general tracks (e.g., geometry, attribute, and occupancy tracks), and a separate metadata box track 702 includes the parameters and grouping information.

As an illustrative example, each EntityToGroupBox 702B in the GroupListBox 702A of the Metabox 702 contains a list of references to entities, which in this example include a list of references to the V-PCC parameter track 706, the geometry track 708, the attribute track 710, and the occupancy track 712. A device uses those referenced tracks to collectively re-construct a version of the underlying point cloud content (e.g., with a certain quality).

Various structures can be used to carry point cloud content. For example, as described in N18479, entitled “Continuous Improvement of Study Test of ISO/IEC CD 23090-5 Video-based Point Cloud Compression”, Geneva, CH (March 2019), which is hereby incorporated by reference herein in its entirety, the V-PCC bitstream may be composed of a set of V-PCC units as shown in FIG. 6. In some embodiments, each V-PCC unit may have a V-PCC unit header and a V-PCC unit payload. The V-PCC unit header describes the V-PCC unit type.

As described herein, the occupancy, geometry, and attribute Video Data unit payloads correspond to video data units that could be decoded by the video decoder specified in the corresponding occupancy, geometry, and attribute parameter set V-PCC units. As described in N18485, entitled “V-PCC CE 2.19 on tiles”, Geneva, CH (March 2019), which is hereby incorporated by reference herein in its entirety, the Core Experiment (CE) may be used to investigate the V-PCC tiles for Video-based PCC as specified in N18479, for meeting the requirements of parallel encoding and decoding, spatial random access, and ROI-based patch packing.

A V-PCC tile may be a 3D bounding box, a 2D bounding box, one or more Independent coding unit(s) (ICUs), and/or an equivalent structure. For example, this is described in conjunction with exemplary FIG. 5 and described in m46207, entitled “Track Derivation for Storage of V-PCC Content in ISOBMFF,” Marrakech, MA (January 2019), which is hereby incorporated by reference herein in its entirety. In some embodiments, the 3D bounding box may be a minimum enclosing box for a given point set in 3 dimensions. A 3D bounding box with the shape of a rectangular parallel-piped can be represented by two 3-tuples. As an example, the two 3-tuples may include the origin and the length of each edge in three dimensions. In some embodiments, the 2D bounding box may be a minimum enclosing box (e.g. in a given video frame) corresponding to the 3D bounding box (e.g. in 3D space). A 2D bounding box with the shape of a rectangle can be represented by two 2-tuples. For example, the two 2-tuples may include the origin and the length of each edge in two dimensions. In some embodiments, there can be one or more independent coding units (ICUs), (e.g., video tiles) in a 2D bounding box of a video frame. The independent coding units may be encoded and decoded without the dependency of neighboring coding units.

In some embodiments, the 3D and 2D bounding boxes may be subdivided into 3D sub-volumetric regions (e.g., octree-based division) and 2D sub-pictures (e.g., quadtree-based division), respectively, (e.g., as provided in m46207, “Track Derivation for Storage of V-PCC Content in ISOBMFF,” Marrakech, MA. (January 2019) and m47355, “On Track Derivation Approach to Storage of Tiled V-PCC Content in ISOBMFF,” Geneva, CH. (March 2019), which are hereby incorporated by reference herein in their entirety) so that they become needed ICUs that are fine enough also from the Systems point of view for delivery and rendering in order to support the viewport dependent media processing for V-PCC media content as described in m46208.

Metadata structures may be used to specify information about sources, regions and their spatial relations, such as by using timed metadata tracks and/or track grouping boxes of ISOBMFF. In order to deliver point cloud content more efficiently, including in live and/or on-demand streaming scenarios, mechanisms like DASH (such as described in “Media presentation description and segment formats,” 3rd Edition, September 2018, which is hereby incorporated by reference herein in its entirety) can be used for encapsulating and signaling about sources, regions, their spatial relations, and/or viewports.

According to some embodiments, for example, a viewport may be specified using one or more structures. In some embodiments, a viewport may be specified as described in the Working Draft of MIV, entitled “Working Draft 2 of Metadata for Immersive Video,” dated July 2019 (N18576) which is hereby incorporated by reference herein in its entirety. In some embodiments, a viewing orientation may include a triple of azimuth, elevation, and tilt angle that may characterize the orientation that a user is consuming the audio-visual content; in case of image or video, it may characterize the orientation of the viewport. In some embodiments, a viewing position may include a triple of x, y, z characterizing the position in the global reference coordinate system of a user who is consuming the audio-visual content; in case of image or video, characterizing the position of the viewport. In some embodiments, a viewport may include a projection of texture onto a planar surface of a field of view of an omnidirectional or 3D image or video suitable for display and viewing by the user with a particular viewing orientation and viewing position.

In order to specify spatial relationships of 2D/3D regions within their respective 2D and 3D sources, some metadata data structures may be specified according to some embodiments described herein, including 2D and 3D spatial source metadata data structures and region and viewport metadata data structures.

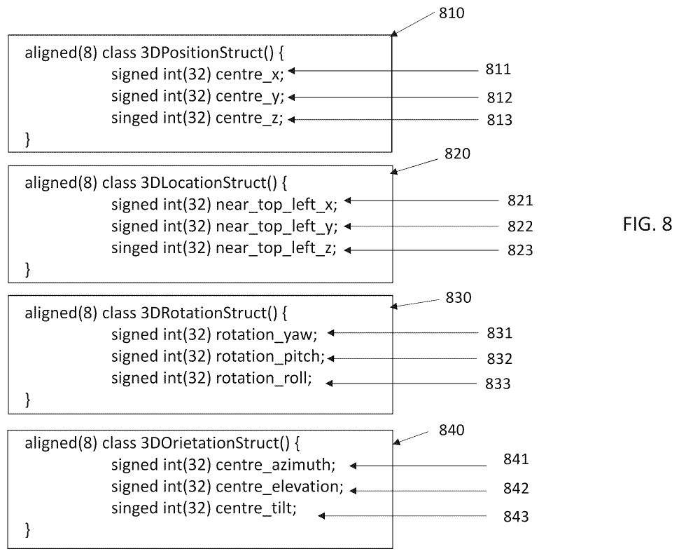

FIG. 8 is an exemplary diagram showing metadata data structures for 3D elements, according to some embodiments. The centre_x field 811, centre_y field 812 and centre_z field 813 of exemplary 3D position metadata data structure 810 in FIG. 8 may specify the x, y and z axis values, respectively, of the centre of the sphere region, for example, with respect to the origin of the underlying coordinate system. The near_top_left_x field 821, near_top_left_y field 822, and near_top_left_z field 823 of exemplary 3D location metadata data structure 820 may specify the x, y, and z axis values, respectively, of the near-top-left corner of the 3D rectangular region, for example, with respect to the origin of the underlying 3D coordinate system.

The rotation_yaw field 831, rotation_pitch field 832, and rotation_roll field 833 of exemplary 3D rotation metadata data structure 830 may specify the yaw, pitch, and roll angles, respectively, of the rotation that is applied to the unit sphere of each spherical region associated in the spatial relationship to convert the local coordinate axes of the spherical region to the global coordinate axes, which may be in units of 2⁻¹⁶ degrees, relative to the global coordinate axes. In some examples, the rotation_yaw field 831 may be in the range of −180*2¹⁶ to 180*2¹⁶−1, inclusive. In some examples, the rotation_pitch field 832 may be in the range of −90*2¹⁶ to 90*2¹⁶, inclusive. In some examples, the rotation_roll field 833 shall be in the range of −180*2¹⁶ to 180*2¹⁶−1, inclusive. The centre_azimuth field 841 and centre_elevation field 842 of exemplary 3D orientation metadata data structure 840 may specify the azimuth and elevation values, respectively, of the centre of the sphere region in units of 2⁻¹⁶ degrees. In some examples, the centre_azimuth 841 may be in the range of −180*2¹⁶ to 180*2¹⁶−1, inclusive. In some examples, the centre_elevation 842 may be in the range of −90*2¹⁶ to 90*2¹⁶, inclusive. The centre_tilt field 843 may specify the tilt angle of the sphere region in units of 2⁻¹⁶ degrees. In some examples, the centre_tilt 843 may be in the range of −180*2¹⁶ to 180*2¹⁶−1, inclusive.

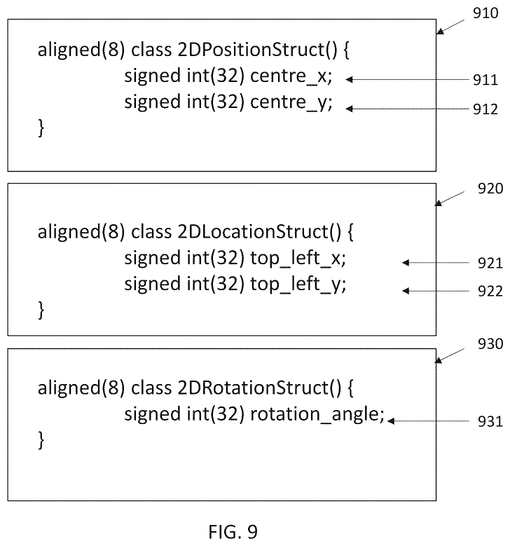

FIG. 9 is an exemplary diagram showing metadata data structures for 2D elements, according to some embodiments. The centre_x field 911 and centre_y field 912 of exemplary 2D position metadata data structure 910 in FIG. 9 may specify the x and y axis values, respectively, of the centre of the 2D region, for example, with respect to the origin of the underlying coordinate system. The top_left_x field 921, and top_left_y field 922 of exemplary 2D location metadata data structure 920 may specify the x, and y axis values, respectively, of the top-left corner of the rectangular region, for example, with respect to the origin of the underlying coordinate system. The rotation_angle field 931 of exemplary 2D rotation metadata data structure 930 may specify the angle of the counter-clock rotation that is applied to each of the 2D regions associated in the spatial relationship to convert the local coordinate axes of the 2D region to the global coordinate axes, for example, in units of 2⁻¹⁶ degrees, relative to the global coordinate axes. In some examples, the rotation_angle 931 may be in the range of −180*2¹⁶ to 180*2¹⁶−1, inclusive.

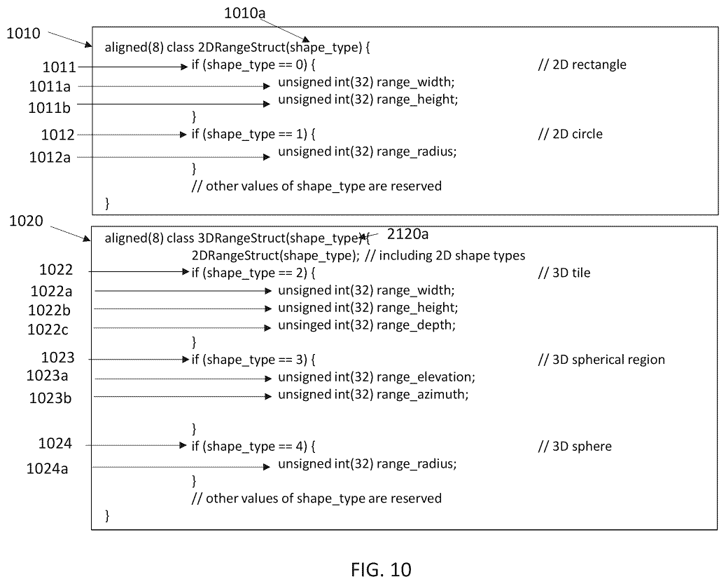

FIG. 10 is an exemplary diagram showing metadata data structures for 2D and 3D range elements 1010 and 1020, according to some embodiments. The range_width fields 1011a and 1022a and range_height fields 1011b and 1022b may specify the width and height ranges, respectively, of a 2D or 3D rectangular region. They may specify the ranges through a reference point of the rectangular region, which could be either the top left point, centre point, and/or the like inferred as specified in the semantics of the structure containing the instances of these metadata. The range_depth field 1022c can specify the depth range of a 3D rectangular region. For example, it may specify the ranges through the centre point of the region. The range_radius fields 1012a and 1024a can specify the radius range of a circular region. The range_azimuth 1023b and range_elevation 1023a may specify the azimuth and elevation ranges, respectively, of the sphere region, for example, in units of 2⁻¹⁶ degrees. The range_azimuth 1023b and range_elevation 1023a may also specify the ranges through the centre point of the sphere region. In some examples, the range_azimuth 1023b may be in the range of 0 to 360*2¹⁶, inclusive. In some examples, the range_elevation 1023a may be in the range of 0 to 180*2¹⁶, inclusive.

The shape_type field 1010a and 1020a may specify a shape type of a 2D or 3D region. According to some embodiments, certain values may represent different shape types of a 2D or 3D region. For example, a value 0 may represent a 2D rectangle shape type, a value 1 may represent a shape type of 2D circle, a value 2 may represent a shape type of 3D tile, a value 3 may represent a shape type of 3D sphere region, a value 4 may represent a shape type of 3D sphere, and other values may be reserved for other shape types. According to the value of the shape_type field, the metadata data structures may include different fields, such as can be seen in the conditional statements 1011, 1012, 1022, 1023 and 1024 of exemplary metadata data structures 1010 and 1020.

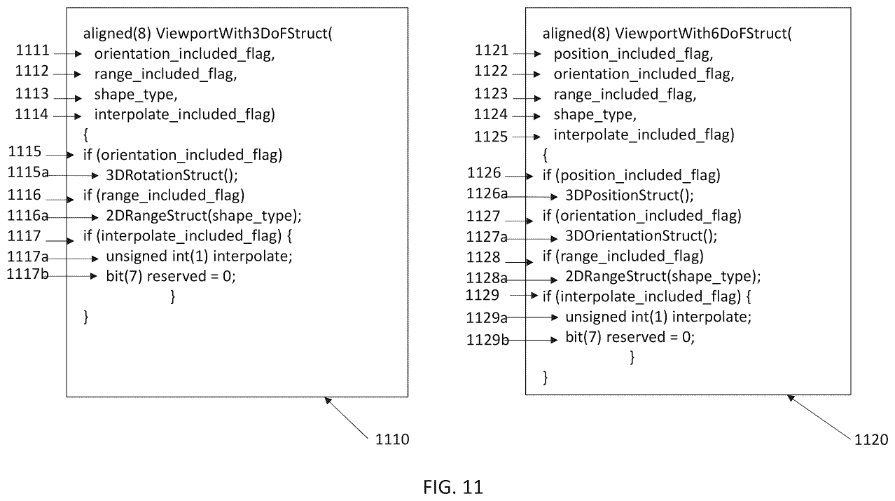

FIG. 11 is an exemplary diagram showing metadata data structures for viewports with 3DoF and 6DoFs 1110 and 1120, according to some embodiments. The viewport with 3DoF 1110 includes the fields orientation_included_flag 1111, range_included_flag 1112, and interpolate_included_flag 1114, which as shown by logic 1115, 1116, and 1117, are used to specify, if applicable, the 3DRotationStruct 1115a, the 3DRangeStruct 1116a, and the interpolate 1117a and reserved field 1117b, accordingly. The fields also include the shape_type 1113. The viewport with 6DoF 1120 includes the fields position_included_flag 1121, orientation_included_flag 1122, range_included_flag 1123, and interpolate_included_flag 1125, which as shown by logic 1126, 1127, 1128, and 1129, are used to specify, if applicable, the 3DPositionStruct 1126a, the 3DOrientationStruct 1127a, the 3DRangeStruct 1128a, and the interpolate 1129a and reserved field 1129b, accordingly. The fields also include the shape_type 1124.

The semantics of interpolate 1117a and 1129a may be specified by the semantics of the structure containing this instance of it. According to some embodiments, in the case that any of the location, rotation, orientation, range, shape and interoperate metadata are not present in an instance of 2D and 3D source and region data structures, they may be inferred as specified in the semantics of the structure containing the instance.

According to some embodiments, a viewport with 3DoF, 6DoF, and/or the like can be signaled using a timed metadata track. In some embodiments, when the viewport is only signaled at the sample entry, it is static for all samples within; otherwise, it is dynamic, with some attributes of it varying from sample to sample. According to some embodiments, a sample entry may signal information common to all samples. In some examples, the static/dynamic viewport variation can be controlled by a number of flags specified at the sample entry.

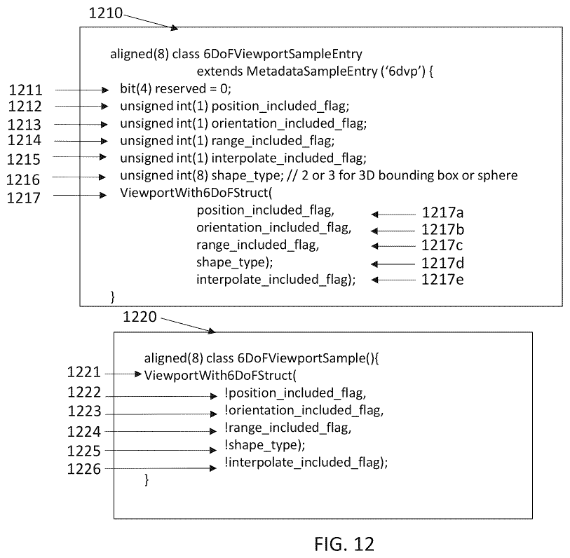

FIG. 12 is a diagram of exemplary sample entry and sample format for signaling a viewport with 6DoF e.g. for 2D faces/tiles in 3D space and/or the like) in timed metadata tracks, according to some embodiments. The 6DoFViewportSampleEntry 1210 includes a reserved field 1211, position_included_flag 1212, orientation_included_flag 1213, range_included_flag 1214, interpolate_included_flag 1215, and shape_type 1216 (which is 2 or 3 for a 3D bounding box or sphere). The fields also include a ViewportWith6DoFStruct 1217, which includes the position_included_flag 1217a, orientation_included_flag 1217b, range_included_flag 1217c, and shape_type 1217d. The fields also include the interpolate_included_flag 1217e. The 6DoFViewportSample 1220 includes a ViewportWith6DoFStruct 1221, which includes the fields !position_included_flag 1222, !orientation_included_flag 1223, !range_included_flag 1224, !shape_type 1225, and !interpolate_included_flag 1226.

Some aspects of the techniques described herein provide for non-cuboid subdivisions of point cloud content. In some embodiments, a non-cuboid subdivision can be used to support partial delivery and access of point cloud data, such as that described in N18850, “Description of Core Experiment on Partial Access of PC Data,” Geneva, Switzerland, October 2019, which is incorporated by reference herein in its entirety. In some embodiments, the non-cuboid subdivisions include spherical and pyramid subdivisions. The non-cuboid subdivisions described herein can be used as additions to cuboid subdivisions, e.g., as described in the revised CD text of the carriage of PC data in ISOBMFF in N18832, “Revised Text of ISO/IEC CD 23090-10 Carriage of Video-based Point Cloud Coding Data,” Geneva, Switzerland, October, 2019, which is hereby incorporated by reference herein in its entirety. The spatial regions that result from the non-cuboid subdivisions can be signaled as static or dynamic regions (e.g., such that the spatial regions can be signaled consistently with cuboid regions). Tracks that carry the resulting spatial regions can be grouped together using track grouping mechanisms, such as those specified in N18832.

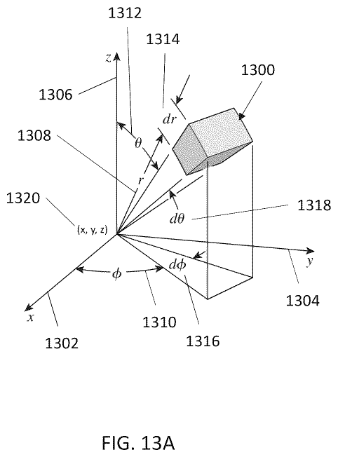

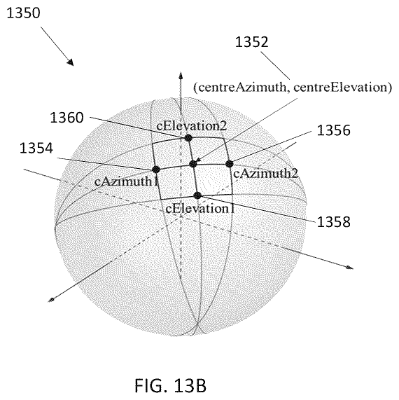

In some embodiments, the techniques provide for spherical subdivisions. A spatial region resulting from a spherical subdivision can be a spherical region, or a differential volume section in spherical coordinates. FIG. 13A shows an exemplary region 1300 specified using spherical coordinates, according to some embodiments. FIG. 13A includes the x, y and z axes 1302, 1304 and 1306, respectively. As shown, the region 1300 can be specified based on central dimensions, including a center r 1308, a center azimuth ϕ 1310, and a center elevation θ 1312. In some embodiments, while not shown, the region 1300 can also be specified using a tilt. The dimensions of the region 1300 can be specified as deltas from the central dimensions using a delta r “dr” 1314, a delta azimuth ϕ “dϕ” 1316, and a delta elevation θ “dθ” 1318.

In some embodiments, the spherical subdivision can be for a single point cloud object (e.g., like the scope of the current revised CD text in N18832). In such embodiments, an origin need not be specified for the spherical subdivision. In some embodiments, if multiple point cloud objects are used, the origin can be assigned with a Cartesian coordinate (x, y, z) 1320 as shown in FIG. 13A.

In some embodiments, spatial region information structure(s) can be used to specify spherical regions. For example, a 3D spherical region structure can provide information of a spherical region of the point cloud data, which is a differential volume section between two spheres with radius r and r+dr, bounded by [r, r+dr]×[ϕ−dϕ/2, ϕ+dϕ/2]×[θ−dθ/2, θ+dθ/2]. Such a specification (e.g., which is slightly different from the region 1300 in FIG. 13A), can use a viewpoint to point to the center of the inner surface of the region, such that the region is a differential extension, along the radius of the viewpoint, to a sphere region structure (e.g., the SphereRegionStruct in the OMAF specification N18865, “Text of ISO/IEC CD 23090-2 2^{nd} edition OMAF,” Geneva, Switzerland, October, 2019, which is hereby incorporated by reference herein in its entirety). FIG. 13B shows an exemplary spherical region structure 1350, according to some embodiments. The center of the sphere region structure is (centerAzimuth, centerElevation) 1352, and the center of two opposing sides is specified by cAzimuth1 1354 and cAzimuth2 1356, while the center of the other two opposing sides is specified by cElevation1 1358 and cElevation2 1360.

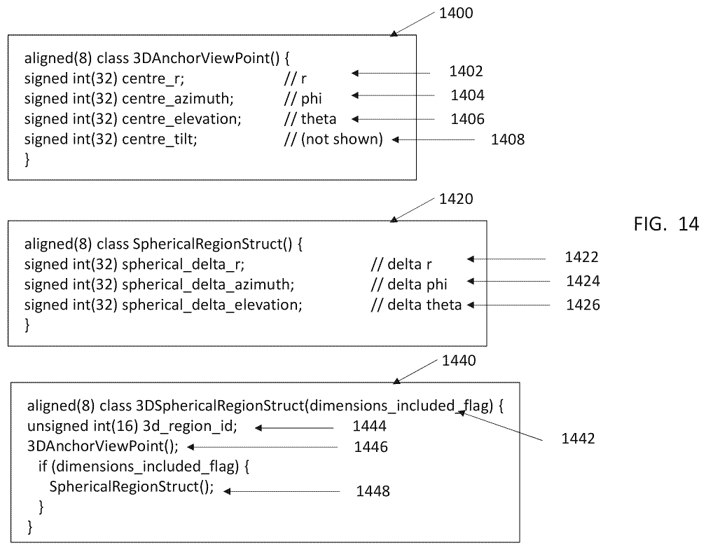

FIG. 14 shows exemplary syntaxes that can be used to specify a spherical region, according to some embodiments. FIG. 14 shows an exemplary 3D anchor viewpoint class “3DAnchorViewPoint” 1400 that includes four integer fields: centre_r 1402 (e.g., shown as center r 1308 in FIG. 13A), centre_azimuth 1404 (e.g., shown as center azimuth ϕ 1310 in FIG. 13A), centre_elevation 1406 (e.g., shown as center elevation θ 1312 in FIG. 13A), and centre_tilt 1408. FIG. 14 also shows an exemplary spherical region structure class “SphericalRegionStruct” 1420 that includes three integer fields: spherical_delta_r (e.g., shown as dr 1314 in FIG. 13A), spherical_delta_azimuth (e.g., shown as dϕ 1316 in FIG. 13A), and spherical_delta_elevation (e.g., shown as dθ 1318 in FIG. 13A). FIG. 14 also shows an exemplary 3D spherical region structure “3DSphericalRegionStruct” class 1440 that takes in the flag dimensions_included_flag 1442. The 3D spherical region structure 1440 includes an integer 3d_region_id 1444, a 3DAnchorViewPoint structure 1446, and if dimensions_included_flag 1442 is true, a SphericalRegionStruct 1448.

In some embodiments, the fields shown in FIG. 14 can be used according to the non-limiting examples that follow. The 3d_region_id 1444 can be an identifier for the spatial region. The centre_r 1402 can specify the radius value r for the viewpoint centre of the spherical region, with respect to the origin of the underlying coordinate system. The centre_azimuth 1404 and centre_elevation 1406 can specify the azimuth and elevation values, respectively, of the centre of the sphere region in units of 2⁻¹⁶ degrees. The centre_azimuth 1404 can be in the range of −180*2¹⁶ to 180*2¹⁶−1, inclusive. The centre_elevation 1406 can be in the range of −90*2¹⁶ to 90*2¹⁶, inclusive. The centre_tilt 1408 can specify the tilt angle of the sphere region in units of 2⁻¹⁶ degrees. The centre_tilt 1408 can be in the range of −180*2¹⁶ to 180*2¹⁶−1, inclusive.

The spherical_delta_r 1422 can specify the radius range of the spherical region. The spherical_delta_azimuth 1424 and spherical_delta_elevation 1426 can specify the azimuth and elevation ranges, respectively, of the spherical region in units of 2⁻¹⁶ degrees. In some examples, the spherical_delta_azimuth 1424 and spherical_delta_elevation 1426 can specify the ranges through the centre point of the spherical region. The spherical_delta_azimuth 1424 can be in the range of 0 to 360*2¹⁶, inclusive. The spherical_delta_elevation 1426 can be in the range of 0 to 180*2¹⁶, inclusive. The dimensions_included_flag 1442 can be a flag that indicates whether the dimensions of the spatial region are signalled.

The spherical subdivisions described herein can relate to the spherical regions in, for example, m50606, “Evaluation Results for CE on Partial Access of Point Cloud Data,” Geneva, Switzerland, October, 2019, which is hereby incorporated by reference herein in its entirety, with shape_type=3 or shape_type=4.

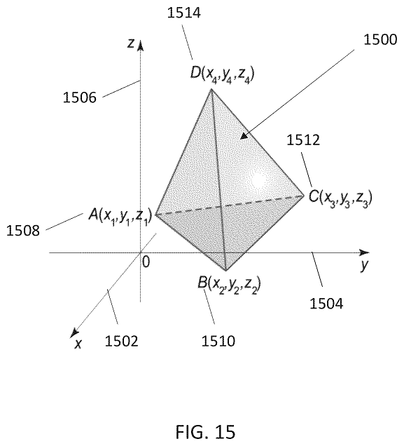

In some embodiments, the techniques provide for a pyramid subdivision. The spatial region of the pyramid subdivision can be a pyramid region. The pyramid region can be the volume formed by four vertices. FIG. 15 shows an exemplary pyramid region 1500, according to some embodiments. FIG. 15 includes the x, y and z axes 1502, 1504 and 1506, respectively. The pyramid region 1500 is specified by vertices (A 1508, B 1510, C 1512, D 1514) in Cartesian coordinates. As should be appreciated from the pyramid region 1500, the pyramid subdivision can be finer than other subdivisions. For example, each cuboid region can be further divided into a number of pyramid regions.

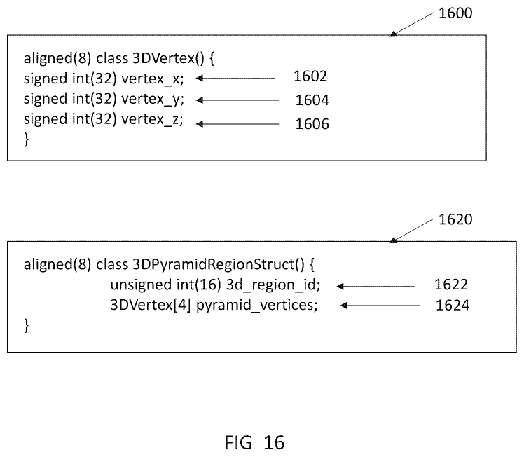

FIG. 16 shows exemplary syntaxes that can be used to specify a pyramid region, according to some embodiments. FIG. 16 shows a 3D vertex “3DVertex” class 1600 that includes three integers for each x, y and z value: vertex_x 1602, vertex_y 1604, and vertex_z 1606. FIG. 16 also shows a 3D pyramid region structure “3DPyramidRegionStruct” class 1620 that includes an integer 3d_region_id 1622 and an array of four 3D vertexes pyramid_vertices 1624.

In some embodiments, the fields shown in FIG. 14 can be used according to the non-limiting examples that follow. The 3d_region_id 1622 can be an identifier for the spatial region. The vertex_x 1602, vertex_y 1604, and vertex_z 1606 can specify the x, y, and z coordinate values, respectively, of a vertex of a pyramid region corresponding to the 3D spatial part of point cloud data in the Cartesian coordinates.

The syntaxes provided above, as with the other exemplary syntaxes provided herein, are intended to be exemplary only and it should be appreciated that other syntaxes can be used without departing from the spirit of the techniques described herein. For example, another structure could be used to store the vertices as a list of triples of coordinates (xᵢ, yᵢ, zᵢ), i=1, . . . , N, and to define a pyramid formed by four vertices using their indices i, j, k, l, in the list, 1≤i≠j≠k≠1≤N.

The non-cuboid subdivision techniques described herein can be used to support flexible signalling of sub-divisions of a point cloud object into a number of 3D spatial sub-regions. The techniques can provide for signalling 3D spatial sub-regions of the point cloud object in non-cuboid forms, including spherical regions formed by a differential volume and a pyramid region formed by four vertices in the 3D space. The non-cuboid regions can be useful, for example, when mapping 3D spatial sub-regions of a point cloud object onto surficial and volumetric viewports. As another example, the spherical subdivision techniques can be useful for point clouds whose points can be within a 3D bounding box and whose shape is spherical rather than cuboid.

The non-cuboid subdivision techniques can support efficient signalling of a mapping between (a) a 3D spatial sub-region of a point cloud object and/or a collection of 3D spatial sub-regions and (b) one or more independently decodable subsets of 2D video bitstream for partial access and delivery (e.g., where independently decodable sets can be specified by V-PCC, the underlying video codec used, etc.). The techniques can provide such support at the file format track grouping level and the timed metadata track level, when individual tracks are used to carry one or more independently decodable subsets of 2D video bitstreams. At the track grouping level, for example, the tracks can be grouped together by having each track include one or more track grouping boxes with a same identifier that contain one or more 3D spatial sub-regions the 2D video bitstream is mapped to. At the time metadata track level, for example, a timed metadata track for a 3D spatial region can reference the one or more tracks for the independently decodable subset of 2D video bitstreams (e.g., which signals the mapping).

In some embodiments, the techniques provide for specifying viewports in six degrees of freedom (6DoF). According to conventional approaches, a 6DoF viewport can be specified using a planar surface. A viewport is, for example, a projection of texture onto a planar surface of a field of view of video content (e.g., an omnidirectional or 3D image or video) that is suitable for display and viewing by the user with a particular viewing orientation and viewing position. A viewing orientation can be specified as a triple of values specifying azimuth, elevation, and a tilt angle characterizing the orientation that a user is consuming the audio-visual content. In the case of an image or video, the viewing orientation can characterize the orientation of the viewport. A viewing position can be specified as a triple of x, y, z values specifying the position in the global reference coordinate system of a user who is consuming the audio-visual content. In the case of an image or video, the viewing position can characterize the position of the viewport. Some conventional metadata structures for viewports using a planar surface, their carriage in timed metadata tracks, and their signalling for V-PCC media content are described in, for example, m50979, “On 6DoF Viewports and their Signaling in ISOBMFF for V-PCC and Immersive Video Content,” Geneva, Switzerland, October, 2019, which is hereby incorporated by reference herein in its entirety.

The techniques described herein provide improvements to conventional viewport technologies. In particular, the techniques described herein can be used to extend viewports beyond surfical specifications that require use of a planar surface. In some embodiments, the techniques can provide for volumetric viewports. The techniques also provide for advanced metadata structures to support volumetric viewports (e.g., in addition to surfical viewports), as well as signalling such viewports in timed metadata tracks in ISOBMFF.

In some embodiments, the techniques generally extend viewports to include not just the projection of texture onto a planar surface, but also the projection of texture onto a spherical surface or spatial volume of a field of view of multimedia content (e.g., an omnidirectional or 3D image or video) suitable for display and viewing by the user with a particular viewing orientation and viewing position.

In some embodiments, surfical viewports can include viewports whose field of view are surficial, and video texture is projected onto a rectangular planar surface, a circular planar surface, a rectangular spherical surface, and/or the like.

In some embodiments, volumetric viewports can generally include viewports whose field of view is volumetric. In some embodiments, video texture can be projected onto a rectangular volume. For example, texture can be projected onto a rectangular frustum volume, as a differential, rectangular volume section (e.g., specified in Cartisan coordinates). In some embodiments, video texture can be proejcted onto a circular volume. For example, texture can be projected onto a circular frustum volume, as a differential, circular volume section (e.g., specified in Cartisan coordinates). In some embodiments, video texture can be proejcted onto a spherical volume. For example, texture can be projected onto a rectangular frustum volume, as a differential, rectangular volume section (e.g., specified in spherical coordinates).

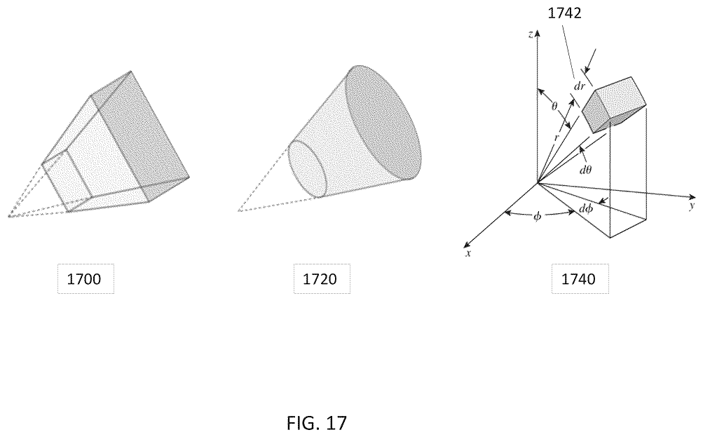

FIG. 17 shows exemplary schematics of volumetric viewports, according to some embodiments. FIG. 17 shows three exemplary volumetric viewports: viewport 1700 with a rectangular frustum volume specified in Cartesian coordinates, viewport 1720 with a circular frustum volume specified in Cartesian coordinates, and viewport 1740 with a rectangular volume specified in spherical coordinates (e.g., as discussed in conjunction with FIG. 13A). Such volumetric viewports can be specified as differential volume expansions (e.g., of a planar surface) along the viewing orientation with some viewing depth, such as dr 1742 for viewport 1740.

Some embodiments provide for metadata structures for volumetric viewports. In some embodiments, metadata structures can be extended to support volumetric viewports (e.g., in addition to surficial viewports). For example, the viewport metadata structures described in m50979 can be extended with information to specify whether the viewport is volumetric, as well as a depth of the viewport. 3D position and orientation structures, such as the 3D position structure 810 and a 3D orientation structure 840 discussed in conjunction with FIG. 8, can be used in conjunction with volumetric viewports.

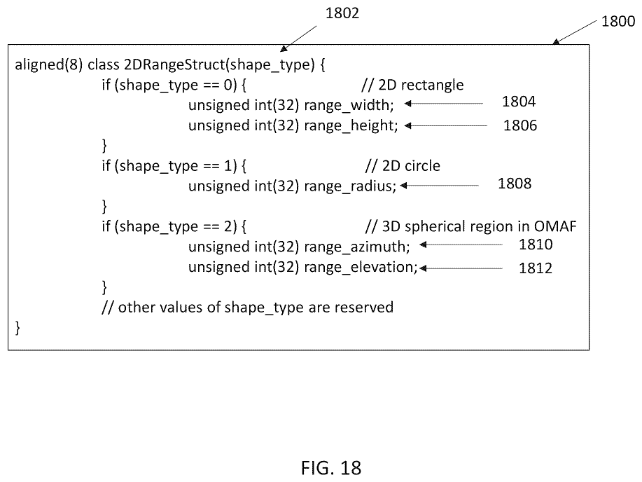

FIG. 18 shows an exemplary 2D range structure 1800 that can specify a volumetric viewport, according to some embodiments. The 2D range structure 1800 takes in as an input shape_type 1802. If the shape_type 1802 is equal to 0, the 2D range structure 1800 can specify a 2D rectangle, and includes the integer fields range_width 1804 and range_height 1806. If the shape_type 1802 is equal to 1, the 2D range structure 1800 can specify a 2D circle, and includes the integer field range_radius 1808. If the shape_type 1802 is equal to 2, the 2D range structure 1800 can specify a 3D spherical region (e.g., in OMAF), and includes the integer fields range_azimuth 1810 and range_elevation 1812.

Therefore, the 2D range structure 1800 (e.g., compared to the 2D range structure 1010 shown in FIG. 10) can extend conventional 2D range structures to specify 3D spherical regions by including the range_azimuth 1810 and range_elevation 1812 fields. The shape_type 1802 can specify a shape of a 2D or 3D surface region, where a value of 0 indicates a 2D rectangle, a value of 1 indicates a 2D circle, and a value of 2 indicates a 3D sphere region (with other values reserved).

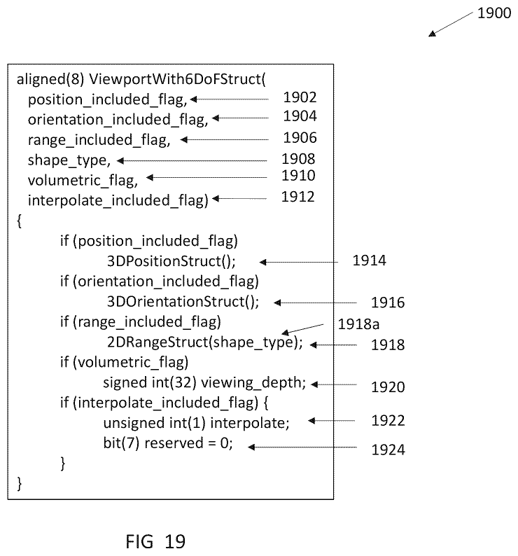

FIG. 19 shows an exemplary viewport with 6DoF structure 1900, according to some embodiments. The viewport with 6DoF structure 1900 takes as input the following flags: position_included_flag 1902, orientation_included_flag 1904, range_included_flag 1906, shape_type 1908, volumetric_flag 1910, and interpolate_included_flag 1912. If position_included_flag 1902 is true, the structure 1900 includes 3DPositionStruct 1914. If orientation_included_flag 1904 is true, the structure 1900 includes 3DOrientationStruct 1916. If range_included_flag 1906 is true, the structure 1900 includes a 2DRangeStruct 1918 (e.g., as discussed in conjunction with FIG. 18) that takes in a shape_type 1918a. If volumetric_flag 1910 is true, the structure 1900 includes an integer field viewing_depth 1920. If interpolate_included_flag 1912 is true, the structure 1900 includes an integer field interpolate 1922 and a reserved field 1924.

Therefore, the structure 1900 can extend structures (e.g., the viewport with 6DoF structure 1120 in FIG. 11) to include the volumetric_flag 1910 that can be used to indicate a viewing_depth 1920. The viewing_depth 1920 can specify the viewing depth along the orientation for volumetric viewports. As described herein, the semantics of interpolate can be specified by the semantics of the structure containing this instance of it. In some embodiments, when any of the position, orientation, range, shape and interpolate metadata are not present in an instance of 6DoF viewport metadata data structures, the values can be inferred as specified in the semantics of the structure containing the instance.

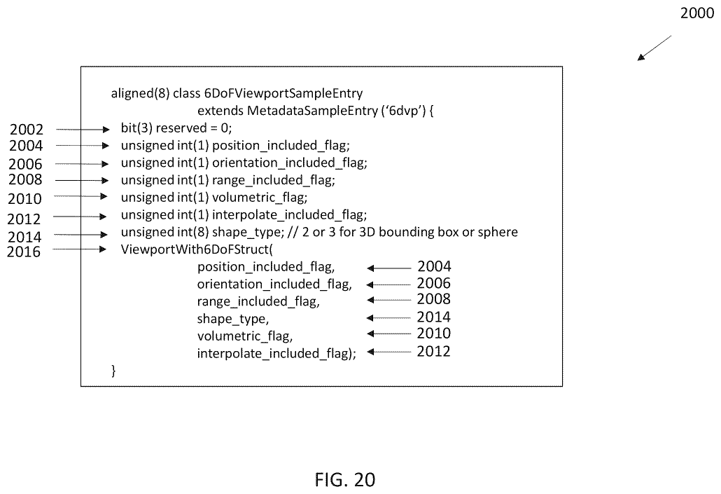

In some embodiments, the techniques can provide for signalling viewports (including 3D regions) in timed metadata tracks. In some embodiments, a sample entry can be used to signal viewports in timed metadata tracks. In some embodiments, metadata structures (such as the 6DoF viewport sample entry 1210 discussed in FIG. 12) can be extended for volumetric viewports. For example, a sample entry of a sample entry type ‘6dvp,’ of the sample description box container ‘stsd’ can be used, which is not mandatory and can include 0 or 1. FIG. 20 shows an exemplary 6DOF viewport sample entry class “6DoFViewportSampleEntry” 2000 that supports volumetric viewports, according to some embodiments. As shown, the metadata sample entry 2000 extends a MetadataSampleEntry (‘6dvp’). The metadata sample entry 2000 includes a reserved field 2002 and number of flags: position_included_flag 2004, orientation_included_flag 2006, range_included_flag 2008, volumetric_flag 2010, and interpolate_included_flag 2012. The metadata sample entry 2000 includes an integer field shape_type 2014 (e.g., that can indicate a 3D bounding box or sphere using a value of 2 or 3, respectively). The metadata sample entry 2000 further includes a ViewportWith6DoFStruct 2016 (e.g., as discussed in conjunction with FIG. 19), which takes as inputs the position_included_flag 2004, orientation_included_flag 2006, range_included_flag 2008, shape_type 2014, volumetric_flag 2010, and interpolate_included_flag 2012.

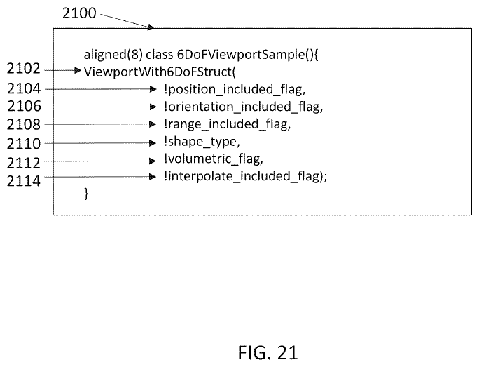

In some embodiments, a sample format can be provided to support volumetric viewports. For example, the 6DoF viewport sample 1220 discussed in conjunction with FIG. 12 can be extended to support volumetric viewports. FIG. 21 shows a 6DoF viewport sample “6DoFViewportSample” 2100 that supports volumetric viewports, according to some embodiments. The 6DoF sample format includes a ViewportWith6DoFStruct 2102, which includes the fields !position_included_flag 2104, !orientation_included_flag 2106, !range_included_flag 2108, !shape_type 2110, !volumetric_flag 2112, and !interpolate_included_flag 2114.

The interpolate flags discussed herein (e.g., interpolate_included_flag 1912, 2012, and/or 2114) can indicate the continuity in time of the successive samples. When true, for example, the application may linearly interpolate values of the ROI coordinates between the previous sample and the current sample. When false, for example, interpolation of values may not be used between the previous and the current samples. In some embodiments, when using interpolation, it can be expected that the interpolated samples match the presentation time of the samples in the referenced track. For instance, for each video sample of a video track, one interpolated 2D Cartesian coordinate sample can be calculated.

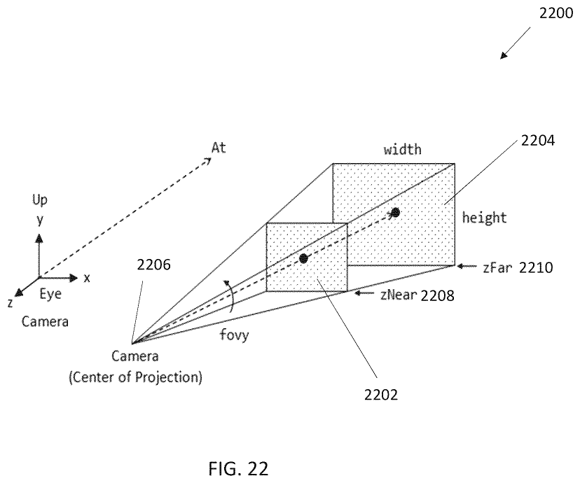

As described herein, volumetric viewports can be differential volumetric expansions along the viewing orientation with a viewing depth. In some embodiments, a volumetric viewport can include a far-side view sharp range specification. In some embodiments, a viewing depth can be signaled. For example, a distance r (such as the distance r discussed in conjunction with dr 1314 in FIGS. 13A and 17) can be signaled. As another example, a ratio between ranges of near and far view shapes can be signaled. FIG. 22 is an exemplary diagram 2200 showing a near view shape 2202 and a far view shape 2204, according to some embodiments. The user/viewer eye (or camera) is at location 2206, and therefore the distance to the near-side shape 2202 and far-side view shape 2204 can be signaled based on location 2206 using zNear 2208 for the near-side shape 2202 and zFar 2210 for the far-side shape 2204. The ratio between the corresponding ranges of the near-side and far-side view shapes 2202 and 2204 can also be signaled (e.g., as zFar 2210/zNear 2208). In some embodiments, widthNear/zNear=widthFar/zFar→widthNear/widthFar=zNear/zFar, and heightNear/zNear=heightFar/zFar→heightNear/heightFar=zNear/zFar. Thus, in some embodiments, widthNear/widthFar=heightNear/heightFar=zNear/zFar.

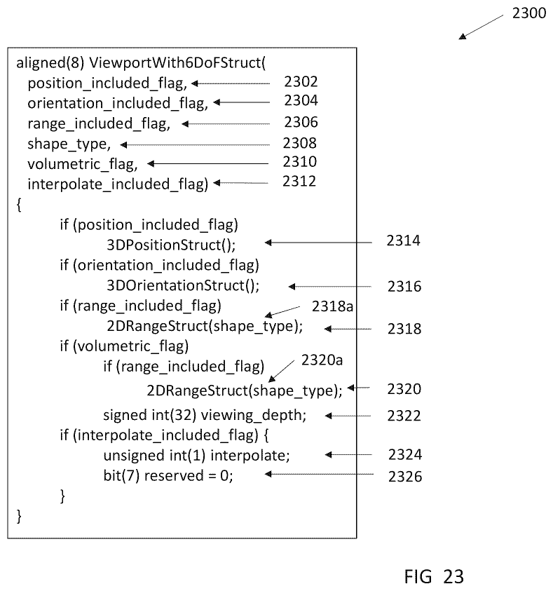

In some embodiments, metadata structures can be used to signal near- and far-side view shape range(s). For example, a far-side view can be incorporated into metadata structures. FIG. 23 shows an exemplary viewport with 6DoF structure 2300 that includes far-side view information, according to some embodiments. The viewport with 6DoF structure 2300 takes as input the following flags: position_included_flag 2302, orientation_included_flag 2304, range_included_flag 2306, shape_type 2308, volumetric_flag 2310, and interpolate_included_flag 2312. If position_included_flag 2302 is true, the structure 2300 includes 3DPositionStruct 2314. If orientation_included_flag 2304 is true, the structure 2300 includes 3DOrientationStruct 2316. If range_included_flag 2306 is true, the structure 2300 includes a 2DRangeStruct 2318 (e.g., as discussed in conjunction with FIG. 18) that takes in a shape_type 2318a. If volumetric_flag 2310 is true, the structure 2300 includes an integer field viewing_depth 2322, and if the range_included_flag 2306 is true, the structure 2300 includes a 2DRangeStruct 2320 that takes in a shape_type 2320a. If interpolate_included_flag 2312 is true, the structure 2300 includes an integer field interpolate 2324 and a reserved field 2326.

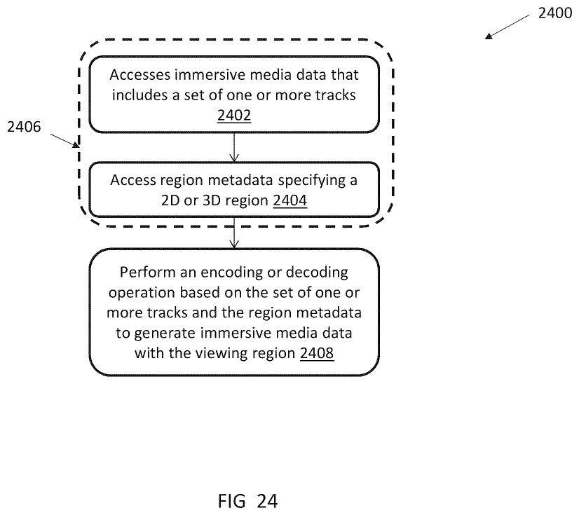

As described herein, the techniques provide for both 2D and 3D regions, including 2D and 3D viewports. FIG. 24 is an exemplary diagram of a computerized method 2400 for encoding or decoding video data for immersive media, according to some embodiments. At steps 2402 and 2404, the computing device (e.g., the encoding device 104 and/or the decoding device 110) accesses immersive media data that includes a set of one or more tracks (step 2402) and region metadata specifying a 2D or 3D region (step 2404). At step 2408, the computing device performs an encoding or decoding operation based on the set of one or more tracks and the region metadata to generate immersive media data with the viewing region.

Steps 2402 and 2404 are shown in the dotted box 2406 to indicate that steps 2402 and 2404 can be performed separately and/or at the same time. Each track received at step 2402 can include associated encoded immersive media data that corresponds to an associated spatial portion of immersive media content that is different than the associated spatial portions of other tracks received at step 2402.

Referring to the region metadata received at step 2404, the region metadata includes the 2D region metadata if the viewing region is a 2D region, or the region metadata includes the 3D region metadata if the viewing region is a 3D region. In some embodiments, the viewing region is a sub-portion of the full viewable immersive media data. The viewing region be, for example, a viewport.

Referring to step 2406, the encoding or decoding operation can be performed by a shape type of the viewing region (e.g., a shape_type field). In some embodiments, the computing device determines a shape type of the viewing region (e.g., a 2D rectangle, a 2D circle, a 3D spherical region, etc.), and decodes the region metadata based on the shape type. For example, the computing device can determine that the viewing region is a 2D rectangle (e.g., shape_type==0), determining a region width and a region height from the 2D region metadata specified by the region metadata (e.g., range_width and range_height), and generate decoded immersive media data with a 2D rectangular viewing region with a width equal to the region width and a height equal to the region height. As another example, the computing device can determine the viewing region is a 2D circle (e.g., shape_type==1), determining a region radius from the 2D region metadata specified by the region metadata (e.g., range_radius), and generate the decoded immersive media data with a 2D circular viewing region with a radius equal to the region radius. As a further example, the computing device can determine the viewing region is a 3D spherical region (e.g., shape_type==2), determine a region azimuth and a region elevation from the 3D data specified by the region metadata (e.g., range_azimuth and range_elevation), and generate the decoded immersive media data with a 3D spherical viewing region with an azimuth equal to the region azimuth and an elevation equal to the region elevation.

In some embodiments, the immersive media data (e.g., in the received set of one or more tracks) can be encoded in non-cuboid subdivisions. For example, a track can include encoded immersive media data that corresponds to a spatial portion of the immersive media specified by a spherical subdivision of the immersive media (e.g., as discussed in conjunction with FIGS. 13A-13B). The spherical subdivision can include a center of the spherical subdivision in the immersive media (e.g., centre_r), an azimuth of the spherical subdivision in the immersive media (e.g., centre_azimuth), and an elevation of the spherical subdivision in the immersive media (e.g., centre_elevation). As another example, a track can include encoded immersive media data that corresponds to a spatial portion of the immersive media specified by a pyramid subdivision of the immersive media (e.g., as discussed in conjunction with FIG. 15). The pyramid subdivision can include four vertices that specify bounds of the pyramid subdivision in the immersive media (e.g., vertices A, B, C and D).

The immersive media data can also include an elementary data track that includes immersive media elementary data. At least one of the received tracks can references the elementary data track. As described herein, the elementary data track can include at least one geometry track with geometry data of the immersive media (e.g., track 708 in FIG. 7), at least one attribute track with attribute data of the immersive media (e.g., track 710 in FIG. 7), and an occupancy track with occupancy map data of the immersive media (e.g., track 712 in FIG. 7). In some embodiments, receiving or accessing the immersive media data therefore includes accessing the geometry data, the attribute data, and the occupancy map data. The encoding or decoding operation can be performed using the geometry data, the attribute data, and the occupancy map data to generate the decoded immersive media data accordingly.

In some embodiments, the region or viewport information can be specified in a V-PCC track (e.g., track 706, if signaled within the immersive media content). For example, initial viewports can be signaled in the V-PCC track. In some embodiments, as described herein, the viewport information can be signaled within separate timed metadata tracks as described herein. As a result, the techniques need not change any content of the media tracks, such as the V-PCC track and/or the other component tracks, and can therefore allow specifying viewports in a manner that is independent of and asynchronized from the media tracks.

Various exemplary syntaxes and use cases are described herein, which are intended for illustrative purposes and not intended to be limiting. It should be appreciated that only a subset of these exemplary fields may be used for a particular aspect and/or other fields may be used, and the fields need not include the field names used for purposes of description herein. For example, the syntax may omit some fields and/or may not populate some fields (e.g., or populate such fields with a null value). As another example, other syntaxes and/or classes can be used without departing from the spirit of the techniques described herein.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A decoding method for decoding video data for immersive media, the method comprising:
accessing immersive media data comprising:
a set of one or more tracks, wherein each track of the set comprises associated encoded immersive media data that corresponds to an associated spatial portion of immersive media content that is different than the associated spatial portions of other tracks in the set of tracks; and
region metadata specifying a viewing region in the immersive media content, comprising:
one or more flags indicating whether the region metadata includes two-dimensional (2D) region data or three-dimensional (3D) region data;
wherein the one or more flags indicate that the region metadata includes the 2D region metadata if the viewing region is a 2D region; and
the region metadata includes (1) the 3D region metadata comprising 3D region orientation and (2) dimensional data comprising a shape type indicating that the region comprises a 3D tile, a 3D sphere, a pyramid, a cylinder, or a cone or arbitrary shape, if the viewing region is a 3D region; and
performing a decoding operation based on the set of one or more tracks and the region metadata to generate decoded immersive media data with the viewing region.

2. The decoding method of claim 1, wherein the viewing region comprises a sub-portion of the viewable immersive media data that is less than a full viewable portion of the immersive media data.

3. The decoding method of claim 2, wherein the viewing region comprises a viewport.

4. The decoding method of claim 1, wherein performing the decoding operation comprises:
determining a shape type of the viewing region; and
decoding the region metadata based on the shape type.

5. The decoding method of claim 4,
wherein determining the shape type comprises determining the viewing region is a 2D rectangle; and
the method further comprises:
determining a region width and a region height from the 2D region metadata specified by the region metadata; and
generating the decoded immersive media data with a 2D rectangular viewing region with a width equal to the region width and a height equal to the region height.

6. The decoding method of claim 4,
wherein determining the shape type comprises determining the viewing region is a 2D circle; and
the method further comprises:
determining a region radius from the 2D region metadata specified by the region metadata; and
generating the decoded immersive media data with a 2D circular viewing region with a radius equal to the region radius.

7. The decoding method of claim 4,
wherein determining the shape type comprises determining the viewing region is a 3D spherical region; and
the method further comprises:
determining a region azimuth and a region elevation from the 3D region metadata specified by the region metadata; and
generating the decoded immersive media data with a 3D spherical viewing region with an azimuth equal to the region azimuth and an elevation equal to the region elevation.

8. The decoding method of claim 1, wherein:
a track from the set of one or more tracks comprises encoded immersive media data that corresponds to a spatial portion of the immersive media specified by a spherical subdivision of the immersive media.

9. The decoding method of claim 8, wherein the spherical subdivision comprises:
a center of the spherical subdivision in the immersive media;
an azimuth of the spherical subdivision in the immersive media; and
an elevation of the spherical subdivision in the immersive media.

10. The decoding method of claim 1, wherein:
a track from the set of one or more tracks comprises encoded immersive media data that corresponds to a spatial portion of the immersive media specified by a pyramid subdivision of the immersive media.

11. The decoding method of claim 10, wherein the pyramid subdivision comprises four vertices that specify bounds of the pyramid subdivision in the immersive media.

12. The decoding method of claim 1, wherein the immersive media data further comprises an elementary data track comprising first immersive media elementary data, wherein at least one track of the set of one or more tracks references the elementary data track.

13. The method of claim 1, wherein the elementary data track comprises:
at least one geometry track comprising geometry data of the immersive media;
at least one attribute track comprising attribute data of the immersive media; and
an occupancy track comprising occupancy map data of the immersive media;
accessing the immersive media data comprises accessing:
the geometry data in the at least one geometry track;
the attribute data in the at least one attribute track; and
the occupancy map data of the occupancy track; and
performing the decoding operation comprises performing the decoding operation using the geometry data, the attribute data, and the occupancy map data, to generate the decoded immersive media data.

14. A method for encoding video data for immersive media, the method comprising:
encoding immersive media data, comprising encoding at least:
a set of one or more tracks, wherein each track of the set comprises associated encoded immersive media data that corresponds to an associated spatial portion of immersive media content that is different than the associated spatial portions of other tracks in the set of tracks; and
region metadata specifying a viewing region in the immersive media content, comprising:
one or more flags indicating whether the region metadata includes two-dimensional (2D) region data or three-dimensional (3D) region data;
wherein the one or more flags indicate that the region metadata includes the 2D region metadata if the viewing region is a 2D region; and
the region metadata includes the 3D region metadata comprising (1) 3D region orientation and (2) dimensional data comprising a shape type indicating that the region comprises a 3D tile, a 3D sphere, a pyramid, a cylinder, or a cone or arbitrary shape, if the viewing region is a 3D region,
wherein the encoded immersive media data can be used to perform a decoding operation based on the set of one or more tracks and the region metadata to generate decoded immersive media data with the viewing region.

15. The method of claim 14, wherein:
a shape type of the viewing region is a 2D rectangle; and
the 2D region metadata specifies a region width and a region height.

16. The method of claim 14, wherein:
a shape type of the viewing region is a 2D circle; and
the 2D region metadata specifies a region radius.

17. The decoding method of claim 4, wherein:
a shape type of the viewing region comprises a 3D spherical region; and
the 3D region metadata specifies a region azimuth and a region elevation.

18. An apparatus configured to decode video data, the apparatus comprising a processor in communication with memory, the processor being configured to execute instructions stored in the memory that cause the processor to perform:
accessing immersive media data comprising:
a set of one or more tracks, wherein each track of the set comprises associated encoded immersive media data that corresponds to an associated spatial portion of immersive media content that is different than the associated spatial portions of other tracks in the set of tracks; and
region metadata specifying a viewing region in the immersive media content, comprising:
one or more flags indicating whether the region metadata includes two-dimensional (2D) region data or three-dimensional (3D) region data;
wherein the one or more flags indicate that the region metadata includes the 2D region metadata if the viewing region is a 2D region; and
the region metadata includes the 3D region metadata comprising (1) 3D region orientation and (2) dimensional data comprising a shape type indicating that the region comprises a 3D tile, a 3D sphere, a pyramid, a cylinder, or a cone or arbitrary shape, if the viewing region is a 3D region; and
performing a decoding operation based on the set of one or more tracks and the region metadata to generate decoded immersive media data with the viewing region.

19. The apparatus of claim 18, wherein the processor is further configured to execute instructions stored in the memory that cause the processor to perform:
determining a shape type of the viewing region is a 2D circle;
determining a region radius from the 2D region metadata specified by the region metadata; and
generating the decoded immersive media data with a 2D circular viewing region with a radius equal to the region radius.

20. The apparatus of claim 18, wherein the processor is further configured to execute instructions stored in the memory that cause the processor to perform:
determining a shape type of the viewing region is a 3D spherical region;
determining a region azimuth and a region elevation from the 3D region metadata specified by the region metadata; and
generating the decoded immersive media data with a 3D spherical viewing region with an azimuth equal to the region azimuth and an elevation equal to the region elevation.
